(19) United States
(12) Patent Application Publication
(10) Pub. No.: US 2013/0023608 A1
(43) Pub. Date: Jan. 24, 2013

(54) Bio-Polymers In Multicomponent Fibers

(71) Applicants: Patti Jean Kellett, Cincinnati, OH (US); Dimitris Ioannis Collias, Mason, OH (US); Eric Bryan Bond, Mainville, OH (US); Isao Noda, Fairfield, OH (US)

(72) Inventors: Patti Jean Kellett, Cincinnati, OH (US); Dimitris Ioannis Collias, Mason, OH (US); Eric Bryan Bond, Mainville, OH (US); Isao Noda, Fairfield, OH (US)

(21) Appl. No.: 13/186,890

(22) Filed: Jul. 20, 2011

(51) Int. Cl. C08L 3/00; C08L 77/00; C08L 67/03; C08L 23/12

(52) U.S. Cl. 524/52; 525/240; 525/190

(57) ABSTRACT

Multicomponent fibers comprising bio-based thermoplastic polymers, and optionally thermoplastic starch are disclosed. Also disclosed are nonwoven webs and articles formed from these fibers.

### FIELD OF THE INVENTION

The present invention relates to multicomponent fibers that include a bio-based thermoplastic polymer and/or a thermoplastic starch, wherein the configuration of the fibers is selected from a sheath-core, an islands-in-the-sea, a segmented pie, a side-by-side, a tipped trilobal, and combinations thereof. The present invention also relates to nonwoven webs and articles containing these fibers.

### BACKGROUND OF THE INVENTION

Thermoplastic polymers such as polypropylene and polyethylene are used in a wide variety of applications. For example, nonwovens such as filters, diapers, and feminine care products, have traditionally been manufactured from synthetic fibers containing thermoplastic polymers. Most thermoplastic polymers, such as polyethylene, polypropylene, and polyethylene terephthalate, are derived from monomers (e.g., ethylene, propylene, and ethylene and terephthalic acid, respectively) that are obtained from non-renewable, fossil-based resources (e.g., petroleum, natural gas, and coal). Thus, the price and availability of these resources ultimately have a significant impact on the price of these polymers. As the availability of these resources decreases, their price escalates as does the price of materials made from polymers derived from these resources.

In addition to the cost associated with fossil-based nonwovens, many consumers display an aversion to purchasing products that are derived from petrochemicals. In some instances, consumers are hesitant to purchase products made from non-renewable fossil-based resources based on their perception that the products are unsafe or toxic. Other consumers may have adverse perceptions about products derived from petrochemicals as being non-environmentally friendly.

Given the great number of consumable products derived from thermoplastic polymers, it would be desirable to provide fibers containing thermoplastic polymers derived from bio-based resources and/or thermoplastic starch, and nonwoven webs and articles produced from these fibers.

### SUMMARY OF THE INVENTION

Provided herein are multicomponent fibers comprising a bio-based thermoplastic polymer and optionally a thermoplastic starch (TPS). The fibers can have a configuration of sheath-core, islands-in-the-sea, segmented pie, side-by-side, tipped trilobal, or a combination thereof. In various cases, the fiber has a sheath-core configuration.

The multicomponent fibers disclosed herein can have components comprising the bio-based thermoplastic polymer, and no TPS. The fiber can comprise one component comprising the bio-based thermoplastic polymer and a second component comprising the TPS. The fiber can comprise at least one component comprising both the bio-based thermoplastic polymer and the TPS. The fibers can have a diameter of less than 200 μm. The fibers can be thermally bondable.

For the fibers disclosed herein, the thermoplastic polymer can comprise a polyolefin, a polyester, a polyamide, copolymers thereof, or combinations thereof. In various cases, the thermoplastic polymer comprises polyethylene and/or polypropylene. The thermoplastic polymer can be selected from the group consisting of polypropylene, polyethylene, polypropylene co-polymers, polyethylene co-polymers, polyethylene terephthalate, polyethylene terephthalate co-polymers, polybutylene terepthalate, polyethylene 2,5-furandicarboxylate, polybutylene succinate, polyamide-6, polyamide-6,6, and combinations thereof. The thermoplastic polymer can have an average molecular weight of 500,000 g/mol or less, about 5,000 g/mol to about 300,000 g/mol, or about 100.000 g/mol to about 200,000 g/mol. The source of the bio-based thermoplastic polymer can be, for example, a microorganism extract, such as a bacterium or a fungus. The fiber can have a bio-based content of at least 10%, at least 25%, at least 50%, or at least 75%, based upon the total weight of the fiber.

For the fibers disclosed herein, the thermoplastic starch can comprise destructurized starch and a plasticizer. The destructurized starch can be starch, hydroxyethyl starch, hydroxypropyl starch, carboxymethylated starch, starch phosphate, starch acetate, a cationic starch, (2-hydroxy-3-methyl(ammoniumpropyl) starch chloride, a starch modified by acid, base, or enzyme hydrolysis, a starch modified by oxidation, or a combination thereof.

The plasticizer can comprise a polyol. Specific examples of polyols contemplated include mannitol, sorbitol, glycerin, and combinations thereof. The plasticizer can be glycerol, ethylene glycol, propylene glycol, ethylene diglycol, propylene diglycol, ethylene triglycol, propylene triglycol, polyethylene glycol, polypropylene glycol, 1,2-propanediol, 1,3-propanediol, 1,2-butanediol, 1,3-butanediol, 1,4-butanediol, 1,5-pentanediol, 1,6-hexanediol, 1,5-hexanediol, 1,2,6-hexanetriol, 1,3,5-hexanetriol, neopentyl glycol, trimethylolpropane, pentaerythritol, sorbitol, glycerol ethoxylate, tridecyl adipate, isodecyl benzoate, tributyl citrate, tributyl phosphate. dimethyl sebacate, urea, pentaerythritol ethoxylate, sorbitol acetate, pentaerythritol acetate, ethylenebisformamide, sorbitol diacetate, sorbitol monoethoxylate, sorbitol diethoxylate, sorbitol hexaethoxylate, sorbitol dipropoxylate, aminosorbitol, trihydroxymethylaminomethane, glucose/PEG, a reaction product of ethylene oxide with glucose, trimethylolpropane monoethoxylate, mannitol monoacetate, mannitol monoethoxylate, butyl glucoside, glucose monoethoxylate, α-methyl glucoside, carboxymethylsorbitol sodium salt, sodium lactate, polyglycerol monoethoxylate, erythriol, arabitol, adonitol, xylitol, mannitol, iditol, galactitol, allitol, malitol, formaide, N-methylformamide, dimethyl sulfoxide, an alkylamide, a polyglycerol having 2 to 10 repeating units, or combinations thereof. Alternatively the plasticizer can be a polymer, such as polyethylene glycol. polyethylene oxide, polyvinyl alcohol or polyethylene vinyl alcohol or combination thereof.

In various cases, the plasticizer is bio-based. Non-limiting examples of bio-based plasticizers include erythritol, arabitol, adonitol. xylitol, mannitol, iditol, galactitol, allitol, malitol, glycerol, ethylene glycol, propylene glycol, ethylene diglycol, propylene diglycol, ethylene triglycol, propylene triglycol, polyethylene glycol, polypropylene glycol, 1,2-propanediol, 1,3-propanediol, 1,2-butanediol, 1,3-butanediol. 1,4-butanediol, 1,5-pentanediol, 1,6-hexanediol, sorbitol, glycerol ethoxylate, tributyl citrate, sorbitol acetate, sorbitol diacetate, sorbitol monoethoxylate, sorbitol diethoxylate, sorbitol hexaethoxylate, sorbitol dipropoxylate, aminosorbitol, glucose/PEG. mannitol monoacetate, mannitol monoethoxylate, butyl glucoside, glucose monoethoxylate, α-methyl glucoside, carboxymethylsorbitol sodium salt, sodium lactate, polyglycerol monoethoxylate, and combinations thereof. Specifically contemplated bio-based plasticizers include erythritol, arabitol, adonitol, xylitol, mannitol, iditol, galactitol, allitol, malitol, and combinations thereof.

Specific fibers contemplated include bicomponent fibers having a sheath-core configuration, the sheath comprising a thermoplastic starch and the core comprising a bio-based thermoplastic polymer. Other specific fibers contemplated are bicomponent fibers having a sheath-core configuration, the core comprising a thermoplastic starch and the sheath comprising a bio-based thermoplastic polymer. Still other fiber structures contemplated are bio-based polyethylene sheath and bio-based polypropylene core, or bio-based polyethylene sheath and bio-based polyethylene terephthalate core, for example.

Further provided are nonwoven webs comprising the fibers as disclosed herein. The nonwoven web can further comprise synthetic or natural fibers. The synthetic or natural fibers can be blended and bonded together with the fibers as disclosed herein.

Disposable articles comprising the nonwoven webs are also contemplated.

All percentages, ratios and proportions herein are by weight. unless otherwise specified. All temperatures are in degrees Celsius (° C.) unless otherwise specified. All documents cited are in relevant part, incorporated herein by reference.

The invention will be more fully understood by reference to the detailed description and the examples. All citations throughout the disclosure are hereby expressly incorporated by reference.

### DETAILED DESCRIPTION OF THE INVENTION

Disclosed herein are multicomponent fibers that include a bio-based thermoplastic polymer and, optionally, a thermoplastic starch. As explained in further detail herein, the fibers are multicomponent in that each fiber has more than one separate part in spatial relationship to another part, each part chemically or physically distinct from the other, and various spatial relationships will provide the fiber with different configurations that can be selected based on the particular end use. The bio-based thermoplastic polymer, described in more detail herein, generally excludes polylactic acid and polyhydroxyalkanoates, but generally includes polyolefins, polyesters, polyamides, and copolymers and combinations thereof. Generally, the bio-based thermoplastic polymer is made from a renewable material obtained from one or more intermediate compounds (e.g., sugars, alcohols, organic acids). In turn, these intermediate compounds can be converted to polymer precursors (e.g., acids, acid esters, acid salts, and olefins), and a variety of known reaction pathways to obtain these intermediate compounds are disclosed herein.

It is contemplated that the multicomponent fibers disclosed herein can be used in any application heretofore employing conventional fibers. For example, the multicomponent fibers disclosed herein can be used to make woven and non-woven webs (or used with conventional woven and non-woven webs) that ultimately are used to make articles, such as disposable absorbent articles, filters, insulation material, fabrics to name a few. The benefits of such use are largely self-evident in that the bio-based thermoplastic polymer and thermoplastic starch (when present) desirably supplant polymers made from non-renewable resources. Further, the use of bio-based thermoplastic polymer and thermoplastic starch (when present) in these applications is not expected to detrimentally affect, from a consumer standpoint, the performance of the articles and is not expected to require complicated or costly reengineering of established processes used to manufacture these articles.

Fibers

The fibers have a bio-based content of at least 10%, at least 25%, at least 50%, or at least 75%, based upon the total weight of the fiber. Other contemplated ranges of the bio-based content of the fibers disclosed herein include about 25% to about 75%, about 25% to about 50%, and about 50% to about 75%, based upon the total weight of the fiber. Specifically contemplated bio-based contents of the fibers disclosed herein include about 10%, about 11%, about 12%, about 13%, about 14%, about 15%, about 16%, about 17%, about 18%, about 19%, about 20%, about 21%, about 22%, about 23%, about 24%. about 25%, about 26%, about 27%, about 28%, about 29%, about 30%. about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, and about 75%, based upon the total weight of the fiber. The remaining non bio-based content of the fiber can comprise petroleum based polymers or additives derived from non-renewable resources.

As used herein, the term “bio-based content” refers to the amount of bio-carbon in a material as a percent of the weight (mass) of the total organic carbon in the product. For example, polyethylene contains two carbon atoms in its structural unit. If ethylene is derived from a renewable resource, then a homopolymer of polyethylene theoretically has a bio-based content of 100% because all of the carbon atoms are derived from a renewable resource. A copolymer of polyethylene could also theoretically have a bio-based content of 100% if both the ethylene and the co-monomer are each derived from a renewable resource. In embodiments where the co-monomer is not derived from a renewable resource, the polymer will typically include only about 1 wt. % to about 2 wt. % of the non-renewable co-monomer, resulting in polymer having a theoretical bio-based content that is slightly less than 100%. As another example, polyethylene terephthalate contains ten carbon atoms in its structural unit (i.e., two from the ethylene glycol monomer and eight from the terephthalic acid monomer). If the ethylene glycol portion is derived from a renewable resource. but the terephthalic acid is derived from a petroleum-based resource, the theoretical bio-based content of the polyethylene terephthalate is 20%. Descriptions of sources of bio-based content for the fibers disclosed herein is provided below.

The fiber can have a diameter of less than 200 μm. The fiber diameter can be 100 μm or less, 50 μm or less, or less than 30 μm. Fibers commonly used to make nonwovens can have a diameter of from about 5 μm to about 30 μm. Fiber diameter is controlled by spinning speed, mass through-put, and blend composition.

The fibers as disclosed herein are not brittle and have a toughness of greater than 2 MPa, and can be greater than 50 MPa, or greater than 100 MPa. Toughness is defined as the area under the stress-strain curve where the specimen gauge length is 25 mm with a strain rate of 50 mm per minute.

The multicomponent fibers as disclosed herein can be thermally bondable if a sufficient amount of thermoplastic polymer is present in the fiber or on the outside component of the fiber (e.g., as a sheath of a bicomponent fiber). Thermally bondable fibers can sustain the pressurized heat and/or thru-air heat bonding methods. A fiber is typically thermally bondable when the thermoplastic polymer is present at a level of greater than about 15%, greater than about 30%, greater than about 40%, or greater than about 50% by weight of the fiber. Consequently, if a very high starch content is in the sheath, the fiber may exhibit a decreased tendency toward thermal bondability.

Configuration of the Fibers

The fibers disclosed herein are multicomponent. Component, as used herein, is defined as a separate part of the fiber that has a spatial relationship to another part of the fiber. The term multicomponent, as used herein, is defined as a fiber having more than one separate part in spatial relationship to one another. The term multicomponent includes bicomponent, which is defined as a fiber having two separate parts in a spatial relationship to one another. The different components of multicomponent fibers are arranged in substantially distinct regions across the cross-section of the fiber and extend continuously along the length of the fiber.

The multicomponent fibers can all be produced by using the materials and methods disclosed herein. Multicomponent fibers, commonly a bicomponent fiber, can be in a side-by-side, sheath-core (concentric or eccentric core), segmented pie, ribbon, tipped trilobal, or islands-in-the-sea configuration. For sheath-core, the sheath may be continuous or non-continuous around the core. The ratio of the weight of the sheath to the core is about 5:95 to about 95:5. The fibers disclosed herein can have different geometries that include round, elliptical, star shaped, rectangular, multilobal (e.g., trilobal), and other various shapes.

The fibers disclosed herein can be splittable fibers. Rheological, thermal, and solidification differential behavior can potentially cause splitting. Splitting may also occur by a mechanical means such as ring rolling, stress or strain, use of an abrasive, or differential stretching, and/or by fluid induced distortion, such as hydrodynamic or aerodynamic distortion.

For a bicomponent fiber having a sheath-core configuration. the sheath can comprise a thermoplastic starch (e.g., destructurized starch and a plasticizer), and the core can include some other materials, e.g., a bio-based thermoplastic polymer. Alternatively, the fiber can have the core containing thermoplastic starch (e.g., a destructurized starch and a plasticizer), and the sheath can include some other polymer, e.g., a bio-based thermoplastic polymer. The exact configuration of the fiber desired is dependent upon the use of the fiber. In some configurations, the thermoplastic starch can be in the sheath and core. Fiber configurations are well known in the art, and are described in detail, e.g., in U.S. Pat. No. 7,851,391, which is incorporated in its entirety by reference.

Bio-based Thermoplastic Polymers

The fibers disclosed herein include at least one component containing a bio-based thermoplastic polymer. Thermoplastic polymers, as used in the disclosed fibers, are polymers that melt and then, upon cooling, crystallize or harden, but can be re-melted upon further heating. Suitable thermoplastic polymers used herein have a melting temperature (also referred to as solidification temperature) of about 60° C. to about 300° C. about 80° C. to about 250° C., or about 100° C. to about 215° C. The term thermoplastic polymer as used herein specifically excludes polylactic acid and polyhydroxyalkanoates.

The molecular weight of the thermoplastic polymer is sufficiently high to enable entanglement between polymer molecules and yet low enough to be melt spinnable. Contemplated weight average molecular weights of the disclosed thermoplastic polymers include 500,000 g/mol or less, about 5,000 g/mol to about 300,000 g/mol, and about 100,000 g/mol to about 200,000 g/mol.

Suitable thermoplastic polymers generally include polyolefins, polyesters, polyamides, copolymers thereof, and combinations thereof. More specifically, the thermoplastic polymer can be polypropylene, polyethylene, polypropylene co-polymer, polyethylene co-polymer, polyethylene terepthalate, polybutylene terepthalate, polyethylene 2,5-furandicarboxylate, polybutylene succinate, polyamide-6, polyamide-6,6, or a combination thereof.

The thermoplastic polymers can include polyolefins such as polyethylene or copolymers thereof, including low, high, linear low, or ultra low density polyethylenes, polypropylene or copolymers thereof, including atactic polypropylene; isotactic polypropylene, metallocene isotactic polypropylene, polybutylene or copolymers thereof.

The thermoplastic polymers can include polyamides or copolymers thereof, such as Nylon 6, Nylon 11, Nylon 12, Nylon 46, and/or Nylon 66.

The thermoplastic polymers can include polyesters or copolymers thereof, such as polybutylene terphthalate, polybutylene succinate, and/or polyethylene terephthalate. Still other examples include maleated polypropylene and acrylic acid modified polypropylene.

Furthermore, the thermoplastic polymers can include olefin carboxylic acid copolymers such as ethylene/acrylic acid copolymer, ethylene/maleic acid copolymer, ethylene/methacrylic acid copolymer, ethylene/vinyl acetate copolymers or combinations thereof. Still other examples are maleated polypropylene and acrylic acid modified polypropylene.

Still further. the thermoplastic polymers can include polyacrylates, polymethacrylates, and their copolymers such as poly(methyl methacrylates).

Other non-limiting examples of suitable thermoplastic polymers include polycarbonates, polyvinyl acetates, poly(oxymethylene), styrene copolymers, polyacrylates, polymethacrylates, poly(methyl methacrylates), polystyrene/methyl methacrylate copolymers, polyetherimides, polysulfones, or combinations thereof. In various embodiments, thermoplastic polymers include polypropylene, polyethylene, polybutylene, polyfurans, polyamides, polyvinyl alcohol, ethylene acrylic acid, polyolefin carboxylic acid copolymers, polyesters, and combinations thereof.

The thermoplastic polymer component can be a single polymer or a blend of two or more thermoplastic polymers as described above.

The bio-based thermoplastic polymer in the disclosed fibers is generated from a renewable material (e.g., derived from a renewable resource). As used herein, a “renewable resource” is one that is produced by a natural process at a rate comparable to its rate of consumption (e.g., within a 100 year time frame). The resource can be replenished naturally, or via agricultural techniques. Non-limiting examples of renewable resources include plants (e.g., sugar cane. beets, corn, potatoes, citrus fruit, woody plants, lignocellulosics, hemicellulosics, cellulosic waste), animals, fish. microorganisms (e.g., bacteria, fungi), and forestry products. These resources can be naturally occurring, hybrids, or genetically engineered organisms. Natural resources such as crude oil, coal, natural gas, and peat, which take longer than 100 years to form, are not considered renewable resources.

Assessment of the renewably based carbon in the multicomponent fibers can be performed through standard test methods. Using radiocarbon and isotope ratio mass spectrometry analysis, the biobased content of materials can be determined. ASTM International, formally known as the American Society for Testing and Materials. has established a standard method for assessing the biobased content of materials. The ASTM method is designated ASTM-D6866. The application of ASTM-D6866 Method B to derive “biobased content” is built on the same concepts as radiocarbon dating, but without use of the age equations. The analysis is performed by deriving a ratio of the amount of radiocarbon (14C) in an unknown sample to that of a modern reference standard. The ratio is reported as a percentage with the units “pMC” (percent modern carbon). If the material being analyzed is a mixture of present day radiocarbon and fossil carbon (containing no radiocarbon), then the pMC value obtained correlates directly to the amount of biomass material present in the sample. The modem reference standard used in radiocarbon dating is a NIST (National Institute of Standards and Technology) standard with a known radiocarbon content equivalent about to the year AD 1950. AD 1950 was chosen since it represented a time prior to thermo-nuclear weapons testing which introduced large amounts of excess radiocarbon into the atmosphere with each explosion (termed “bomb carbon”). The AD 1950 reference represents 100 pMC. “Bomb carbon” in the atmosphere reached almost twice normal levels in 1963 at the peak of testing and prior to the treaty halting the testing. Its distribution within the atmosphere has been approximated since its appearance. showing values that are greater than 100 pMC for plants and animals living since AD 1950. It has gradually decreased over time with today's value being near 107.5 pMC. This means that a fresh biomass material such as corn could give a radiocarbon signature near 107.5 pMC. Combining fossil carbon with present day carbon into a material will result in a dilution of the present day pMC content. By presuming 107.5 pMC represents present day biomass materials and 0 pMC represents petroleum derivatives, the measured pMC value for that material will reflect the proportions of the two component types. For example, a material derived 100% from present day soybeans would give a radiocarbon signature near 107.5 pMC. If that material was diluted with 50% petroleum derivatives, it would give a radiocarbon signature near 54 pMC.

Processes for Making Bio-based Thermoplastic Polymers

The thermoplastic polymers as used in the fibers disclosed herein are derived from renewable resources via an indirect route involving one or more intermediate compounds. Suitable intermediate compounds derived from renewable resources include sugars. Suitable sugars include monosaccharides, disaccharides, trisaccharides, and oligosaccharides. Sugars such as sucrose, glucose, fructose, maltose can be readily produced from renewable resources such as sugar cane and sugar beets. Sugars can also be derived (e.g., via enzymatic cleavage) from other agricultural products such as starch or cellulose. For example, glucose can be prepared on a commercial scale by enzymatic hydrolysis of corn starch. While corn is a renewable resource in North America, other common agricultural crops can be used as the base starch for conversion into glucose. Wheat, buckwheat, arracaha, potato. barley, kudzu, cassava, sorghum, sweet potato, yam, arrowroot, sago, and other similar starchy fruits, seeds, or tubers can also be used in the preparation of glucose.

Other suitable intermediate compounds derived from renewable resources include monofunctional alcohols such as methanol or ethanol and polyfunctional alcohols such as glycerol. Ethanol can be derived from many of the same renewable resources as glucose. For example, cornstarch can be enzymatically hydrolyzed to yield glucose and/or other sugars. The resultant sugars can be converted into ethanol by fermentation. As with glucose production, corn is an ideal renewable resource in North America; however, other crops can be substituted. Methanol can be produced from fermentation of biomass. Glycerol is commonly derived from the hydrolysis of triglycerides present in natural fats or oils. which can be obtained from renewable resources such as animals or plants.

It is also contemplated that suitable intermediates including organic acids (e.g., citric acid. lactic acid, alginic acid, amino acids, etc.), aldehydes (e.g., acetaldehyde), and esters (e.g., cetyl palmitate, methyl stearate, methyl oleate, etc.) can be derived from renewable resources. Additional intermediate compounds such as methane and carbon monoxide can also be derived from renewable resources by fermentation and/or oxidation processes.

Intermediate compounds derived from renewable resources can be converted into polymers (e.g., glycerol to polyglycerol) or they can be converted into other intermediate compounds in a reaction pathway that ultimately leads to a polymer useful in a nonwoven article. An intermediate compound can be capable of producing more than one secondary intermediate compound. Similarly, a specific intermediate compound can be derived from a number of different precursors, depending upon the reaction pathways utilized. Particularly desirable intermediates include (meth)acrylic acids and their esters and salts, and olefins. In various embodiments, the intermediate compound can be acrylic acid, ethylene, propylene, or butylene. Acrylic acid, ethylene, propylene, or butylene can be derived from renewable resources via a number of suitable routes. Examples of such routes are provided below. Various routes are separately described below merely for convenience; it will be appreciated that one or more features of one or more routes can be combined or substituted to generate a desired intermediate, increase yield, or produce the synthetic polymer.

Olefins, such as ethylene and propylene, can also be derived from renewable resources. For example, methanol derived from fermentation of biomass can be converted to ethylene and or propylene, which are both suitable monomeric compounds for preparing the synthetic polymers, as described in U.S. Pat. Nos. 4,296,266 and 4,083,889. U.S. Pat. No. 4,296,266 describes a process for the manufacture of lower olefins (e.g., C₂₋₄ olefins) from methanol and/or dimethyl ether using a manganese-containing aluminum silicate catalyst washed with EDTA or a tartaric acid solution with a pH of 3 to 7. Examples of possible aluminum silicates are the customary, amorphous acid cracking catalysts, which in general contain about 13% to about 25% by weight of aluminum oxide and about 75% to about 87% by weight of silica. Naturally occurring or synthetic crystalline aluminum silicates are also suitable, such as those which are known, for example, by names such as faujasites, zeolites, chabasites, analcime, gismondite, gmelinite, natrolite, mordenites and erionites, or generally as molecular sieves. U.S. Pat. No. 4,083,889 describes a process for manufacturing ethylene by catalytic conversion of a methanol feed in the presence of steam or water diluent. The process is optionally independent of petroleum feedstocks, as the methanol feed can be manufactured from synthesis gas, i.e., a mixture of CO and H₂. The presence of the steam diluent n the process induces sustained high catalytic activity with high selectivity for the formation of ethylene while retaining high conversion levels. Suitable catalysts include zeolite catalysts, such as HZSM-5, a crystalline aluminosilicate zeolite, and the conversion is conducted at relatively low temperature, e.g., from about 600° F. to about 750° F. The hydrocarbon conversion product is an olefin-rich hydrocarbon mixture, containing a high concentration of ethylene, e.g., at least 18 wt. %.

U.S. Patent Application Publication No. 2010/0069691 describes an integrated process for the production of one or more olefins from methanol suitable for use in the thermoplastic polymers, as disclosed herein. In one aspect, the method includes a fermentation and/or gasification reaction of lignocellulosic materials and/or other organic components contained in residue of a renewable natural agricultural raw material, resulting in the production of a mixture of carbon monoxide and hydrogen (syngas), which is converted to methanol. Propylene is formed from methanol. directly or indirectly from the intermediate dimethyl ether, using, e.g., the processes described herein and described in U.S. Pat. Nos. 4,929,780 and 6,534,692 and European Patent Application No. 448000. The transformation of methanol and/or dimethyl ether into propylene can take place in one or more reactors arranged in series allowing recycling of unreacted intermediates. Suitable catalysts for propylene formation include, but are not limited to, zeolites of the aluminosilicate, borosilicate and ferrosilicate types; and highly crystalline metallic aluminophosphates including, e.g., silicon, magnesium, zinc, iron, cobalt, nickel, manganese, chromium, and mixtures thereof. Any set of reaction conditions promoting formation of polypropylene are used, exemplary conditions being a temperature of from about 250° C. to about 800° C. (e.g., about 300° C. and 550° C.) and a pressure ranging from about 10 to about 100 kPa, depending on the type of catalyst employed. Hydrogen activating metal catalysts and high temperatures have been demonstrated to produce hydrocarbon from cellulosic biomass, and are suitable for producing absorbent polymer precursors, such as polypropylene. Japanese Patent Application No. 5213778, for example, describes a high temperature process for generating hydrocarbon from cellulosic biomass using a nickel catalyst. Cellulosic biomass (about 1 wt. %), such as wood, is exposed to a hydrogen activating metal catalyst (about 0.1-1 wt. %), such as a nickel metal catalyst; an alkali substance (about 0.1-0.5 wt. %), such as sodium hydride; and an aqueous medium (about 5-48 wt. %) at about 300° C. to about 400° C. under about 90 to about 220 atm H₂.

Ethanol or propanol derived from fermentation of a renewable resource can be converted into monomeric compounds of ethylene or propylene via dehydration as described in, e.g., U.S. Pat. No. 4,423,270. U.S. Pat. No. 4.423.270 provides a process for the catalytic dehydration of ethanol vapor to ethylene using a supported organophosphorus catalyst. Similarly, propanol or isopropanol derived from a renewable resource can be dehydrated to yield the monomeric compound of propylene as exemplified in U.S. Pat. No. 5,475,183. Propanol is a major constituent of fusel oil, a by-product formed from certain amino acids when potatoes or grains are fermented to produce ethanol. Suitable catalysts include a γ-alumina catalyst, which contains 0.3% by weight or less of impurities in total (excluding SiO₂), or 0.1% by weight or less. Sulfur content in the impurities can be 0.2% by weight or less, 0.1% by weight or less, or 0.06% by weight or less, calculated in terms of SO₄. Sodium content in the impurities can be 0.05% by weight or less or 0.03% or less, calculated in terms of Na₂O. When the sum total of impurities in the γ-alumina catalyst are restricted within the aforementioned ranges, catalyst conversion into the α-form is minimized and, therefore, catalytic activity does not decrease after use in the dehydration reaction for a prolonged period of time at a temperature of from about 150° C. to about 500° C. under pressure. In addition, a γ-alumina catalyst with reduced sodium content improves the yield of the dehydration reaction. Such a process produces olefins from alcohols with high yield and high selectivity for a prolonged period of time without compromising the catalytic activity.

Similarly, propanol or isopropanol derived from a renewable resource can be dehydrated to yield the monomeric compound of propylene as exemplified in U.S. Pat. No. 5,475,183. Propanol is a major constituent of fusel oil, a by-product formed from certain amino acids when potatoes or grains are fermented to produce ethanol. Alternatively, charcoal derived from biomass can be used to create a mixture of syngas from which hydrocarbons such as ethane and propane can be prepared (Fischer-Tropsch Process). Ethane and propane can he dehydrogenated to yield the monomeric compounds of ethylene and propylene.

In addition, short chain acids such as acetic acid or propionic acid can be esterified and hydrogenated to produce a short chain alcohol. The alcohols can then be dehydrated to make the relevant olefin. In one aspect, short chain carboxylic acids such as acetic acid and propionic acid can be derived from naturally occurring organisms such as acetogens (e.g., Clostridium thermoaceticum) or propionibacteria (e.g., Proprionbacterium freudenreichii), respectively. Examples of these processes include those published in U.S. Pat. No. 6,509,180. In another aspect, short chain carboxylic acids can also be produced by carbonylation of methanol or ethanol. A traditional process uses cobalt carbonyl catalysts with iodide and another process uses rhodium carbonyls with iodide to make acetic acid. A more efficient process, as demonstrated in GB 2290200, uses an iridium carbonyl catalyst. Carbonylation of ethanol makes propionic acid in a similar process. U.S. Pat. No. 5,414,161 describes the process to convert methanol to ethanol. CA Patent No. 2,639,806 describes the process of converting biomass to ethanol.

Additional renewable processes for producing propylene include contacting ethylene with a metathesis catalyst to form a metathesis product stream including propylene. Examples of these processes include those described in U.S. Patent Application Publication No. 2008/0312485, U.S. Patent Application Publication No. 2010/0168487, U.S. Pat. No. 4,242,531, and U.S. Pat. No. 6,586,649. U.S. Patent Application Publication No. 2008/0312485 describes a reaction scheme for converting ethanol to propylene via metathesis while minimizing catalyst deterioration, which is caused by the presence of water in ethanol derived from biomass. First, ethanol (e.g., ethanol obtained from biomass) is dehydrated to form ethylene. Ethylene is then separated from the water byproduct of the dehydration reaction and purified by adsorption. Suitable adsorbents depend on the impurities to be removed and include, but are not limited to, alumina, magnesium oxide or a mixture thereof, and zeolite. A metathesis reaction is then carried out with the resulting ethylene and n-butene. N-butene is obtained by any method, including methods described in detail in U.S. Patent Application Publication No. 2008/0312485. Prior to use in the metathesis reaction, water and polar substances are removed from n-butene. When carrying out the metathesis reaction, any molar ratio of ethylene and n-butene can be used. In some variations, an excessive amount of ethylene is utilized. The ratio of ethylene to n-butene is about 0.1 to about 50 or about 0.5 to about 5. A metathesis catalyst optionally contains at least one kind of metal including, but not limited to, tungsten, molybdenum, rhenium, niobium, tantalum, vanadium, ruthenium, rhodium, iridium, osmium, and nickel. The reaction scheme is further described in U.S. Patent Application Publication No. 2008/0312485.

Another method of propylene production by metathesis is described in U.S. Patent Application Publication No. 2010/0168487. The process described in U.S. Patent Application Publication No. 2010/0168487 includes reacting a feed stream containing isobutene in the presence of a skeletal isomerization catalyst to obtain an isomerized stream containing C₄ olefins, and reacting the isomerized stream with ethylene in the presence of a metathesis catalyst to form a metathesis product stream containing propylene, C₄ olefins, and C₅ and higher olefins. The step of reacting the isomerized stream with ethylene, i.e. the metathesis reaction, is performed at an equal or lower pressure than the step of reacting the feed stream, i.e., the skeletal isomerization step. In some aspects, the pressure of the metathesis reaction is conducted at about 15 psig to about 100 psig. In particular aspects, the metathesis reaction pressure is about 20 psig to about 60 psig. One advantage of the process is that it does not require cooling the isomerized stream, pressurizing it, then heating it up again to a temperature suitable for the metathesis reaction and, therefore, the process saves energy.

Yet another method of producing propylene via metathesis is described in U.S. Pat. No. 4,242,531. which describes methods for olefin dimerization using a loop reactor. In one aspect, all or part of the desired product is removed as a vapor by flashing the reactor effluent in a flashing zone, optionally within the loop of the loop reactor. Unconverted ethylene can be recovered for recycling in an absorber utilizing a heavies product stream, which is a product of the process, as the absorbent. A liquid gas absorber contactor within the loop reactor also can be used to concentrate the olefin. The process and apparatus described in U.S. Pat. No. 4,242,531 are suitable for use with any appropriate dimerization catalyst, such as any hydrocarbon-soluble nickel compound, alkyl aluminum halide, or a mixture thereof, e.g., tri-n-butylphosphine nickel dichloride mixed with ethyl aluminum dichloride or bis(tri-n-butyl-phosphine)dichloronickel. The ethylene in the feed gas is dimerized to butenes, which are much more easily recovered and separated from the gases than ethylene. Additionally, removal of most of the major product as a vapor allows retention of the catalyst in the reactor for a longer period of time, thereby improving catalyst productivity.

Butene metathesis, described in, e.g., U.S. Pat. No. 6,586,649, is also contemplated as a means for producing propylene. The process includes contacting a starting material containing butene with a catalyst under conditions suitable for forming propylene. The catalyst includes, for example, a catalytic amount of at least one metal oxide selected from oxides of the transition metals. Catalysts include, but are not limited to, oxides of molybdenum. oxides of rhenium, oxides of tungsten, and mixtures thereof. The catalyst is optionally supported on a solid ceramic support of silica, alumina, titania, zirconia or mixtures thereof, wherein the transition metal oxide forms about 1% to about 30% of the total heterogeneous catalyst mass. The metathesis reaction is optionally performed at a temperature of about 300° C. to about 600° C. and a pressure of about 1-20 atmospheres. Hydrocarbons other than propylene produced by the metathesis reaction are separated from the product and recycled back into contact with the catalyst to increase the yield.

Renewable methods for producing propanol, which can be dehydrated to yield the monomeric compound of propylene, are provided in U.S. Patent Application Publication No. 2009/0246842, published European Patent Application No. 2184354, U.S. Patent Application Publication Nos. 2010/0203604 and 2010/0209986, and WO 2010/127303. U.S. Patent Application Publication No. 2009/0246842 describes methods and compositions for the production of propanol, such as propanol from bio-based precursors. More specifically, U.S. Patent Application Publication No. 2009/0246842 describes engineered microorganisms that produce isopropanol in high yield by biochemically converting a carbon source to acetyl-CoA and converting acetyl-CoA to isopropanol. At least one enzyme of the fermentative pathway is heterologous to the microorganism, and the host cells are cultured under conditions suitable for producing isopropanol. In various aspects, the microbe is engineered to produce an exogenous protein (or overproduce an endogenous protein) catalyzing one or more of the following conversions: Acetyl-CoA to Acetate and CoA (mediated by, e.g., phosphate acetyltransferase and acetate kinase); Acetyl-CoA to Acetoacetyl-CoA and CoA (mediated by, e.g., acetyl-CoA acetyltransferase); Acetoacetyl-CoA and Acetate to Acetoacetate and Acetyl-CoA (mediated by, e.g., acetoacetyl-CoA: acetate/butyrate coenzyme-A transferase); Acetoacetyl-CoA+H₂O Acetoacetate+CoA (mediated by, e.g., acetoacetyl-CoA hydrolase); Acetoacetate to Acetone and CO₂ (mediated by, e.g., acetoacetated carboxylase); and Acetone and NAD(P)H and H⁺ to isopropanol and NAD(P)⁺ (mediated by, e.g., secondary alcohol dehydrogenase). Materials and methods for producing the recombinant microbe, as well as methods of using the recombinant microorganisms to produce isopropanol, are further described in U.S. Patent Application Publication No. 2009/0246842.

U.S. Patent Application Publication No. 2010/0203604 also describes recombinant microorganisms containing an engineered metabolic pathway for producing isopropanol via an acetoacetate-CoA intermediate. The recombinant microorganism, e.g., an aerobic bacterium or a facultative anaerobic bacterium, contains an exogenous (or overexpressed) polynucleotide encoding an enzyme having acetyl-CoA acetyltransferase activity, an exogenous (or overexpressed) polynucleotide encoding an enzyme having acetoacetyl-CoA:acetate CoA-transferase activity, an exogenous (or overexpressed) polynucleotide encoding an enzyme having acetoacetate decarboxylase activity, and an exogenous (or overexpressed) polynucleotide encoding an enzyme having isopropanol dehydrogenase activity. Examples of suitable recombinant microorganisms include, but are not limited to Escherichia coli, Coryneform bacteria, Streptococcus, Staphylococcus, Enterococcus, Bacillus and Streptomyces; fungus cells, such as Aspergillus; and yeast cells, such as baker's yeast and Pichia pastoris. These organisms efficiently produce high levels of isopropanol because they are capable of rapid proliferation under aerobic conditions. To produce isopropanol, the recombinant microorganism is cultured in a medium containing saccharides, and isopropanol is collected from the culture. Materials and methods for producing propanol using recombinant microbes, including polynucleotide sequences encoding the above-mentioned enzymes, are further described in U.S. Patent Application Publication No. 2010/0203604. Published European Patent Application No. 2184354, also published as U.S. Patent Application Publication No. 2010/0311135, describes bacterium producing an acetoacetate decarboxylase (E.C. 4.1.1.4), an isopropyl alcohol dehydrogenase (E.C. 1.1.1.80), a CoA transferase (E.C. 2.8.3.8) and a thiolase (E.C. 2.3.1.9). The bacterium are capable of generating isopropyl alcohol from plant-derived material. The enzymes are not native to the host and are not produced at a higher level than achieved in nature. The microbe is cultured in the presence of plant material (e.g., root, stem, stalk, branch, leaf, flower, seed, degradation products of any of the foregoing, or carbon sources derived from any of the foregoing, such as starch, glucose, fructose, sucrose, xylose, arabinose, glycerin and fatty acids) under conditions suitable for producing isopropanol. Isopropanol is collected from the culture medium by various means, including a production apparatus containing (i) a culturing unit; (ii) a gas-supplying unit connected to the culturing unit and opening at a position in the mixture contained in the culturing unit; (iii) a capture unit containing at least the capture liquid that captures isopropyl alcohol; and (iv) a connecting unit that connects the culturing unit with the capture unit and allows isopropyl alcohol evaporated in the culturing unit to move to the capture unit.

An alternative method of generating alcohol precursors to polymers is described in U.S. Patent Application Publication No. 2010/0209986, which discloses use of metabolically-modified microorganisms for producing, e.g., isobutanol, 1-butanol, 1-propanol, 2-methyl-1-butanol, 3-methyl-1-butanol or 2-phenylethanol, from a 2-keto acid (e.g., 2-ketobutyrate), which is a metabolite generated in an organism's native amino acid pathway. In one aspect, the microorganism contains an exogenous polynucleotide (or overexpressed polynucleotide) encoding an enzyme that catalyzes the condensation of pyruvate and acetyl-coA. In this regard, the microorganism contains an exogenous polynucleotide (or overexpressed polynucleotide) encoding 2-keto-acid decarboxylase (e.g., pdc, pdc1, pdc5, pdc6, aro10, thi3, kivd, or kdcA) and/or an acetohydroxy acid synthase and/or an acetohydroxy acid isomeroreductase and/or a dihydroxy-acid dehydratase and/or an alcohol dehydrogenase and/or a citramalate synthase (cimA). Alternatively, the microorganism contains an exogenous polynucleotide (or overexpressed polynucleotide encoding a citramalate synthase in combination with an exogenous polynucleotide (or overexpressed polynucleotide) encoding α-isopropylmalate synthase and/or β-isopropylmalate dehydrogenase and/or isopropylmalate isomerase and/or threonine dehydratase. Optionally, the recombinant microorganism contains one or more deletions or knockouts in a gene encoding an enzyme that catalyzes the conversion of acetyl-coA to ethanol; catalyzes the conversion of pyruvate to lactate; catalyzes the conversion of fumarate to succinate; catalyzes the conversion of acetyl-coA and phosphate to CoA and acetyl phosphate; catalyzes the conversion of acetyl-CoA and formate to CoA and pyruvate; catalyzes the condensation of the acetyl group of acetyl-CoA with 3-methyl-2-oxobutanoate (2-oxoisovalerate); catalyzes isomerization between 2-isopropylmalate and 3-isopropylmalate: catalyzes the conversion of α-keto acid to branched chain amino acids; catalyzes the synthesis of phenylalanine, tyrosine, aspartate, or leucine: catalyzes the conversion of pyruvate to acetyl-CoA; catalyzes the formation of branched chain amino acids; catalyzes the formation of alpha-ketobutyrate from threonine; catalyzes the first step in methionine biosynthesis; and/or catalyzes the catabolism of threonine. Modifying an organism's native amino acid pathways to produce higher alcohols avoids the difficulty of expressing a large set of exogenous genes in the microbe and minimizes the possible accumulation of toxic intermediates.

An additional metabolic pathway for producing isopropanol includes 4-hydroxybutyryl-CoA as a precursor. WO 2010/127303, also published as U.S. Patent Application Publication No. 2010/0323418. provides non-naturally occurring microbial organisms including one or more exogenous nucleic acid(s)encoding an activity mediating the conversion of 4-hydroxybutyryl-CoA to crotonoyl-CoA. the hydration of crotonoyl-CoA to form 3-hydroxybutyryl-CoA, the oxidation of 3-hydroxybutyryl-CoA to form acetoacetyl-CoA, and/or the conversion of acetoacetyl-CoA to form isopropanol. In this regard, the recombinant microorganism includes one or more exogenous (or overexpressed) nucleic acid(s) encoding any one or more of the following: a 4-hydroxybutyryl-CoA dehydratase, a crotonase, a 3-hydroxybutyryl-CoA dehydrogenase, an acetoacetyl-CoA synthetase, an acetyl-CoA:acetoacetate-CoA transferase, an acetoacetyl-CoA hydrolase, an acetoacetate decarboxylase, and an acetone reductase. U.S. Patent Application Publication No. 2010/0323418 further describes a non-naturally occurring microbial organism having an engineered butanol pathway or isobutanol pathway. The microorganisms are cultured in the presence of a carbon source, such as glucose, for a sufficient time and under suitable conditions for producing alcohol. Materials and methods for producing the recombinant microorganisms, as well as fermentation conditions for producing propanol are further described in U.S. Patent Application Publication No. 2010/0323418. Fermentation-based methods for converting biomass to intermediates or the synthetic polymer also are described in, e.g., U.S. Pat. No. 4,698.304, U.S. Patent Application Publication No. 2007/0031919, and WO 2010/001078. U.S. Pat. No. 4,698,304 discloses methods for producing mixtures of saturated or unsaturated C₂-C₅ hydrocarbons by aerobically cultivating a microorganism in a water-containing medium, and recovering the hydrocarbon mixtures from the liquid phase or/and gaseous ambience of the medium. A wide variety of genera is suitable for use in the method, including (but not limited to) fungi (such as Saprolegenia, Phytophthola, Mucor, Rhizopus, Absidia, Mortierella, Cunninghamella, Taphrina, Monascus, Nectria, Gibberella, Chaetomium, Neurospora, Geotrichum, Monilia, Tricoderma, Aspergillus, Penicillium, Paecilomyces, Glyocladium, Sporotrichum, Microsporum, Trichophyton, Cladosporium, Syncephalastrum, Phycomyces, or Eupenicillium), yeast (such as Endomyces, Shizosaccharomyces, Saccharomyces, Pichia, Hansenula, Dabaryomyces, Saccharomyeopsis, Rhodotorula, Sporobolomyces, Cryptococcus, Candida, or Brettanomyces), bacteria (such as Bacillus, Brevibacterium, Corynebacterium, Flavobacterium, Klebsiella, Micrococcus, Mycoplana, Paracoccus, Proteus, Pseudomonas, Salmonella, Serratia, or Acetobacter), and Actinomycetes (such as Streptomyces, Actinomyces, or Intrasporangium). Industrial wastes and various biomasses are optionally utilized as nutrient sources in the cultivation. Optionally, vitamins and/or amino acids (L-leucine, L-isoleucine, L-methionine, and/or L-cysteine) are added to the culture to enhance strain growth or improve hydrocarbon yields. Alcohol production is accomplished under mild conditions, including relatively low temperature and low pressure, and the impurity gases are mostly carbon dioxide. As a result, hydrocarbon mixtures produced by the method described U.S. Pat. No. 4,698,304 are easy to collect, concentrate, and recover.

U.S. Patent Application Publication No. 2007/0031919 provides additional methods of producing polymer precursors from biomass via fermentation. Biomass is pretreated, at relatively high concentrations, with a low concentration of ammonia relative to the dry weight of the biomass. Following pretreatment, the biomass is treated with a saccharification enzyme consortium to produce fermentable sugars, e.g. oligosaccharides and monosaccharides, that can be used as a carbon source by a microorganism in a fermentation process. The sugars are then contacted with a microbe that ferments the sugars to produce a target chemical. In various embodiments, the method includes (a) contacting the biomass with an aqueous solution containing ammonia at a concentration of less than about weight percent relative to the dry weight of the biomass, but at a concentration at least sufficient to maintain the alkaline pH of the biomass-aqueous ammonia mixture. The dry weight of the biomass is optionally at a high solids concentration of at least about 15 weight percent relative to the weight of the biomass-aqueous ammonia mixture. The method further includes (b) contacting the product of step (a) with a saccharification enzyme consortium under suitable conditions to produce fermentable sugars. The saccharification enzyme consortium optionally includes at least one enzyme selected from the following: cellulose-hydrolyzing glycosidases, hemicellulose-hydrolyzing glycosidases, starch-hydrolyzing glycosidases, peptidases, lipases, ligninases, feruloyl esterases, cellulases, endoglucanases, exoglucanases. cellobiohydrolases, β-glucosidases. xylanases, endoxylanases, exoxylanases. β-xylosidases, arabinoxylanases, mannases, galactases, pectinases, glucuronidases. amylases, α-amylases, β-amylases, glucoamylases, α-glucosidases, and isoamylases. The method further includes (c) contacting the product of step (b) with at least one microbe able to ferment the sugars to produce the target chemical under suitable fermentation conditions. Any microbe that uses fermentable sugars can be used to make the target chemical(s), and examples of microbes include (but are not limited to) wild type, mutant, or recombinant Escherichia, Zymomonas, Candida, Saccaromyces, Pichia, Streptomyces, Bacillus, Lactobacillus and Clostridium. In various embodiments, the biomass is switchgrass, waste paper, sludge from paper manufacturing, corn grain, corn cobs, corn husks, corn stover, grasses, wheat, wheat straw, hay, barley, barley straw, rice straw, sugar cane bagasse, sorghum, soy, components obtained from processing of grains, trees, branches, roots, leaves, wood chips, sawdust, shrubs and bushes, vegetables, fruits, flowers and/or animal manure. WO 2010/001078 describes processes for biologically producing alkenes by enzymatic decarboxylation of 3-hydroxyalkanoic acids.

More particularly, terminal alkenes are produced by enzymatic decarboxylation of 3-hydroxyalkanoate molecules using, e.g., an MDP decarboxylase (E.C. 4.1.1.33). In one aspect, the process includes a 3-phospho-hydroxyalkanoate intermediate, and the enzyme contains both decarboxylase and phosphorylase activity. The method can be implemented in cell-free systems or by using a microorganism that produces the decarboxylase (endogenously or exogenously). Materials and methods for producing terminal alkenes are further described in WO 2010/001078. Additional catalytic methods of producing propylene or precursors thereof are described in, e.g., U.S. Patent Application Publication Nos. 2010/0069589, 2009/0326293. 2006/0020155. and 2010/0069691; U.S. Pat. No, 7,102,048; European Patent Application No. 2108635; Japanese Patent Application No. 5213778; and WO 2010/096812. WO 2008/103480, and WO 2009/073938.

In various embodiments, low molecular weight (C₂₋₄) olefin intermediates are produced by first converting a renewable resource to syngas. Biomass including, but not limited to, corn stover, switchgrass, sugar cane bagasse, sawdust, and a variety of starting materials including, but not limited to, methanol, ethanol, and glycerol CaO be converted to syngas. Biomass is converted to syngas using a variety of methods, including thermal gasification, thermal pyrolysis and steam reforming, and/or hydrogasification, each of which can produce syngas yields of 70-75% or more. Catalytic steam gasification can give high yields of syngas at relatively low temperatures. The syngas formed is converted via Fischer-Tropsch synthesis using a catalyst with low chain growth probabilities (such as an iron catalyst) to a composition consisting of C₂₋₄ olefins, which are then isolated to form a C₂₋₄ olefin-rich stream. Propylene, in various aspects, is isolated from this stream, and ethylene and butylene are subjected to olefin metathesis to produce propylene. Then, propylene, or other olefins, is optionally subjected to a variety of polymerization conditions to yield polypropylene for use in an absorbent article. The process is further described in, e.g., U.S. Patent Application Publication No. 2010/0069589.

Olefins alternatively are obtained from triglycerides, which are optionally obtained from vegetable and/or animal biomass, via hydroconversion and catalytic cracking of a triglycerides feed containing concentrations of fatty acids above 85%, which maximizes the yields of light olefins while reducing the yield of gasoline. See U.S. Patent Application Publication No. 2009/0326293. The process includes, in various aspects, hydroconverting a feed containing triglycerides in contact with a hydrogen-rich gas stream on a catalyst of metal oxides to produce three fractions: (1) a fraction of fuel gas and water vapor; (2) a gaseous fraction constituted principally of propane; and (3) a liquid fraction of saturated hydrocarbons (C₉-C₁₈) and dissolved gases. The method further includes separating the liquid fraction of saturated hydrocarbons and fluid catalytic cracking the separated liquid fraction in petrochemical conditions with a catalyst bed constituted predominantly of zeolites, in proportions between about 30 and 70 wt. %. The process provides greater selectivity for light olefins, e.g., ethylene and propylene, as well as enhanced conversion when compared with cracking of hydrogenated diesel oil or fluid catalytic cracking of organic oil containing triglycerides, without the hydroconversion stage.

Propylene and other olefins also are obtainable from carboxylic acid, which optionally is generated from sugars and/or other biomass. In one aspect, biomass is fermented to produce carboxylic acid. Other organic intermediates derivable from biomass via fermentation include, but are not limited to, ethanol butyric acid, 3-hydroxybutyrate, lactic acid, citric acid, succinic acid, malic acid, acetic acid, propionic acid, oxaloacetic acid, and hydroxyalkanoates. The carboxylic acid is then decarboxylated to produce CO₂ and one or more hydrocarbon compounds, for example, an alkane or an alkene (such as propane or ethylene). Such reactions occur, in various instances, under hydrothermal conditions, and, optionally, with electrolysis of the reactants. For example, if the carboxylic acid (or other organic intermediate) includes a hydroxide moiety, the carboxylic acid is dehydrated, i.e., reacted such that the hydroxide moiety is removed from the molecule as H₂O. A hydrocarbon compound can then be further reacted to produce other compounds, for example, hydrocarbons having at least 4 carbon atoms, and polymers, such as polypropylene. Decarboxylation of carboxylic acid precursors to yield propylene or precursors thereof is further described in WO 2008/103480. also published as U.S. Patent Application Publication No. 2010/228067, which provides reaction conditions for converting polyhydroxybutyrate or butyric acid to propylene at Examples 1 and 2.

Olefins also are obtainable from C₂₋₆ carboxylic acid or a C₂₋₆ carboxylate using, e.g., the decarboxylation-based method described in WO 2010/096812. Carboxylic acids are obtained from biomass by a variety of approaches, such as thermochemical, catalytic, and biochemical treatment. For instance, short-chain aliphatic carboxylic acids or salts thereof are generated from sugars by hydrolysis followed by fermentation. The decarboxylation of the carboxylic acid or carboxylate is carried out using various supported metal catalysts. In various aspects, the method includes contacting a solution containing a C₂₋₆ carboxylic acid or a C₂-carboxylate with a solid catalyst to form a C₁₋₅ hydrocarbon. If desired, the solution is carried by a gas (e.g., hydrogen, an inert gas, or mixture thereof) to contact the solid catalyst. The solid catalyst includes a metal (e.g., Fe, Co, Ni, Mn, Ru, Rh, Pd, Re, Os, Ir, Pt, Sn, Cu, Ag, and Au) or a combination thereof, and a substrate (e.g., a metal oxide, metal sulfide, metal nitride, metal carbide, a zeolite, a molecular sieve, a perovskite, a clay, and a carbonaceous material) or a combination thereof. A representative catalyst is 3 wt % Au/Co₃O₄ catalyst. The reaction conditions can vary depending on the solution composition and catalyst used; exemplary reaction conditions include a temperature of about 25° C. to about 500° C. (e.g., about 200° C. to about 350° C. or about 250° C. to about 400° C.) and a pressure of about 1 to about 30 atm (e.g., about 1 to about 10 atm or about 5 to about 15 atm).

Ethanol is a suitable starting material for producing olefins, including propylene, using. e.g., the methods described in European Patent Application No. 2108635 Ethanol is introduced into a reactor as a stream under a partial pressure of at least about 0.2 MPa. The stream is contacted with a catalyst at conditions effective to convert at least a portion of the ethanol to ethylene, propylene, and olefins having 4 carbon atoms or more (C₄+olefins). The effluent is recovered and fractionated to remove water and unconverted ethanol, thereby producing a stream containing ethylene and C₄+ olefins. At least a part of the stream, optionally mixed with a stream containing C₄+ olefins, is introduced into an Olefin Cracking Processing (OCP) reactor. When present, the mixture includes at least 10 wt. % of C₄+ olefins. The ethylene stream (optionally containing the C₄+ olefins stream) is reacted with a catalyst selective for light olefins to produce a second effluent with an olefin content of lower molecular weight than that of the feedstock. The second effluent is fractionated to produce at least an ethylene stream, a propylene stream, and a fraction consisting essentially of hydrocarbons having 4 carbon atoms or more. Ethylene is optionally recovered and cracked on a catalyst to yield more propylene.

In an alternative process, ethanol is converted to ethylene, olefins having 4 carbon atoms or more (C₄+ olefins), and minor amounts of propylene by, e.g., a) introducing ethanol in a reactor a stream under a partial pressure of at least 0.2 MPa and optionally further containing water and/or an inert component; b) contacting the stream with a catalyst under conditions effective to convert at least a portion of the ethanol to ethylene and a C₄+ olefin fraction; and c) recovering an effluent including ethylene, olefins having 4 carbon atoms or more (C₄+ olefins), propylene, and water (optionally also including unconverted ethanol and/or inert component). The catalyst is, in various aspects, a crystalline silicate having a ratio Si/Al of at least about 100, a dealuminated crystalline silicate, or a phosphorus modified zeolite. The reaction is carried out at a temperature ranging from about 280° C. to about 500° C. Materials and methods associated with the process are further described in European Patent Application No. 2108635.

Monomeric propylene can be derived from ethylene via hydroformylation and hydrogenation. First, ethylene, derived from a renewable resource as described above, is converted to propionaldehyde by hydroformylation with carbon monoxide and hydrogen in the presence of a catalyst such as cobalt octacarbonyl or rhodium. The propionaldehyde can then be hydrogenated over a hydrogenation catalyst such as nickel or with a reagent such as sodium borohydride or lithium aluminum hydride to produce propanol. The propanol can then be dehydrated to produce propylene. U.S. Patent Application Publication No. 2007/0219251 and BR Application No. 2006004284 (Publication No. 20080603) exemplify this process.

Monomeric propylene is also derivable from methanol using any of a number of reaction schemes, including chemical processes known in the art. For example. U.S. Pat. No. 7,102,048 describes processes of making a methanol feed and subsequent processing of the methanol feed to produce olefins and/or an olefin stream. In merely a representative process, methanol is first generated from a carbon source (e.g., biomass). One method of generating methanol consists of converting the carbon source to syngas, and converting the syngas to the methanol composition. Conventional processes for converting carbon components to syngas include steam reforming, partial oxidation, and autothermal reforming. For example, contacting a synthesis gas stream with a carbon oxide conversion catalyst forms a crude methanol stream containing methanol, ethanol and acetaldehyde. The methanol composition is separated from the crude methanol stream and contacted with an olefin forming catalyst to form an olefin stream. An example of an olefin forming catalyst is a molecular sieve catalyst, such as, but not limited to, a silicoaluminophosphate molecular sieve. Another method of forming light olefins, e.g., ethylene and propylene, from methanol and/or from syngas employs a dimethyl ether intermediate. Methanol and/or methanol-containing syngas is first exposed to a catalyst (e.g., an acidic γ-alumina, a modified zeolite, mordenite, a zeolite, ZSM-5, sulfonic acid ion exchange resin, or a perfluorinated sulfonic acid ionomer) to produce dimethyl ether and water. The dimethyl ether is contacted with a second catalyst, such as a molecular sieve catalyst composition (e.g., molecular sieve catalyst composed of SAPO-5, SAPO-8, SAPO-11, SAPO-16, SAPO-17, SAPO-18, SAPO-20, SAPO-31, SAPO-34, SAPO-35, SAPO-36, SAPO-37, SAPO-40, SAPO-41, SAPO-42, SAPO-44, SAPO-47, SAPO-56, ZSM-5, metal containing forms thereof, intergrown forms thereof. AEI/CHA intergrowths, or mixtures thereof) to generate light olefins and water. The first reaction zone (methano) to dimethyl ether) optionally is in a fixed bed reactor, and the second reaction zone (dimethyl ether to light olefin) optionally is in a fluidized reactor. For additional information regarding the materials and methods for converting methanol to propylene via a dimethyl ether intermediate, see, e.g., U.S. Patent Application Publication No. 2006/0020155.

Glycerol also is a suitable precursor for propylene, as described in WO 2009/073938, which discloses a high temperature (about 170° C. to about 380° C.) process for transforming glycerol and/or biomass by heterogenic catalysis for the production of olefins. In some aspects, glycerol used in the catalytic process is raw glycerol from alcoholysis of grease raw materials. Solid acid and/or crystalline basic and/or amorphous catalyzers are described in WO 2009/073938 and include, but are not limited to, aluminum oxides, magnesium oxides, silicon oxides, sodium oxides, and calcium oxides. Solid catalysts can be crystalline as zeolites, like MFI, LTA and MOR; and/or lamellar aluminum magnesium oxides, like hydrotalcite; and/or amorphous solids, like Niobia HY(R) and calcium oxide. The crystalline materials are mixed with ligands, inerts, and peptizing and/or chelating agents to obtain catalyzers with desired size, porosity, texture, and catalytic activity. The catalytic process is carried out in fixed or fluidized bed reactors with high temperature, positive pressure varying between about 60 mm Hg to about 11400 mm Hg, and inert atmosphere with nitrogen flux or in the presence of air. In various embodiments, linkage of the reactors to a distillation column for product recovery completes the process.

Bio-poly(ethylene terephthalate) (PET) is a thermoplastic polymer that is often used in packaging and product applications (e.g. fibers, films, and bottles). It is composed of two monomers—ethylene glycol and terephthalic acid. In one contemplated synthesis, the monomers are reacted together via a condensation reaction using catalysts at high temperatures to form a prepolymer with water as a byproduct. The prepolymers are then transesterified under high vacuum and temperature conditions to obtain the polymer. Achieving the high molecular weights needed for packaging and product applications requires high purity materials. The ester of terephthalic acid can also be used to make the polymer with the methyl ester being most common. The use of esters of terepthalic acid is no longer common since high purity terephthalic acid is available. PET can be partially or fully derived from renewable and sustainable materials. Several of these are shown in U.S. Patent Application Publication No. 2010/0028512.

Ethylene glycol, which is used in PET synthesis, can he derived from renewable resources by several means. In one approach, ethylene derived from the dehydration of ethanol or from any other source based on renewable materials, is oxidized to ethylene oxide using an oxidation catalyst such as silver based materials. The ethylene oxide is subsequently hydrolyzed to yield ethylene glycol. This reaction route is commonly practiced with petroleum based ethylene. Alternatively, catalytic hydrocracking of sugars or cellulose can lead to the formation of 1,2-ethylene glycol. This method is exemplified in U.S. Patent Application Publication No. 2009/0143612 or U.S. Patent Application Publication No. 2010/0255983. The ethylene glycol generated from these processes can be polymerized with terephthalic acid (TPA) that is derived from petroleum based or bio-based materials to give a partially or fully renewable material, respectively.

In general, the means of producing terephthalic acid can be subdivided into routes containing hydrocarbons such as p-xylene or other routes that use oxygenated bio-based starting materials, p-xylene and p-cymene can be obtained via numerous processes. One such route involves the dehydration of isobutanol to produce isobutene. The isobutene intermediate is then dimerized to iso-octene and then cyclized and aromatized to yield p-xylene. U.S. Pat. Nos. 3,202,725; 4,229,320; 4,247,726; 6,600,081; and 7,067,708 teach the process for catalytic cyclization. Alternatively, p-xylene xylene can be produced from biomass. U.S. Patent Application Publication No. 2009/0227823 demonstrates the process of catalytic pyrolysis of biomass that yields aromatic hydrocarbons including p-xylene. Similarly, U.S. Patent Application Publication Nos. 2008/0216391 exhibits the synthesis of chemicals from oxygenated feedstocks via a process called aqueous reforming with p-xylene being one of the products. In another route, p-xylene is produced from bio-methane, as exhibited in WO 2010124041. The bio-methane is halogenated to produce CH₃Br and converted to aromatics via catalysis. In yet another route, p-xylene is produced from 5-hydroxymethylfurfural HMF is derived from fructose or other sugars via acid catalyzed dehydration and then converted to 2,5-dimethylfuran. The dimethylfuran is subsequently reacted with ethylene via a Diels Alder reaction to produce a bicyclic material, which is then dehydrated to produce p-xylene. This process is exhibited in U.S. Patent Application No. 2010/0331568. In another process, limonene or other mono-terpenes are dehydrogenated to produce p-cymene. The p-cymene can be oxidized to produce terephthalic acid. The TPA can then be used to make polyethylene terephthalate, as shown in U.S. Patent Application Publication No. 2010/0028512 and 2010/0168461.

Alternatively, terephthalic acids can be generated from oxygenated starting materials such as muconic acid or furan-2,5-dicarboxylic acid. For example, the Diels Alder reaction of ethylene with muconic acid, as shown in U.S. Patent Application Publication No. 2010/0314243; WO 2010/148063; WO 2010/148070; WO 2010/148081 and WO 2011/017560 exhibit the use of muconic acid, which is obtained by fermentation of an engineered organism, to produce terephthalic acid or dimethyl terephthalate. The muconic acid is reacted with ethylene to obtain cyclohexene 1,4-dicarboxylate that can be dehydrogenated to produce TPA. Alternatively, the Diels Alder reaction of ethylene with furan-2,5-dicarboxylic acid (FDCA) produces TPA. U.S. Pat. No. 7,385,081 exemplifies the reaction of ethylene with furan-2,5-dicarboxylic acid to produce a bicyclic material, which when dehydrated produces TPA. FDCA is produced from the oxidation of 5-hydroxymethylfurfural (HMF) from sugars.

An alternative to bio-based polyethylene terephthalate is poly(ethylene furandicarboxylate) (PEF), which can he produced from renewable materials. PEF can be a renewable or partially renewable polymer that has similar thermal and crystallization properties to PET. PEF serves as either a sole replacement or a blend with petro-based PET (or another suitable polymer) in spunbond fibers. The subsequent production of a nonwovens based on these fibers therefore contain renewable materials. Examples of these PEFs are described in WO 2009/076627 and WO 2010/077133, the disclosures of which are herein incorporated by reference.

Poly(butylene succinate) is an aliphatic polyester made from the condensation polymerization of butanediol and succinic acid, which has properties that are useful for nonwovens and other packaging materials. In addition, copolymers can be made with 1,3-propanediol, 1,2-propanediol, adipic acid, terephthalic acid, isosorbate, and other monomers commonly used for polyesters. Furthermore. these aliphatic polyesters are biodegradable, which is advantageous for their use in nonwoven articles. The synthesis of these polymers have been exemplified in patents EP 569145, EP 572256, and U.S. Patent Application Publication No. 2010/0151167. The use of poly(butylene succinate) in nonwoven articles is shown in EP 569154 and WO 2002/010489. The monomers of poly(butylene succinate) and similar polyesters can be made as follows: succinic acid via fermentation of organisms, as described in CN 2006/10038113, WO 2009/014289, WO 2009/083756, WO 2009/065780, WO 2010/003728, and WO 2011/063055; butanediol via fermentation of genetically modified organisms with sugar, as described in WO 2010/141920, WO 2010/076324, WO 2010/085731, and WO 2010/06076; adipic acid produced from sugar (e.g., WO 2011/003034, U.S. Patent Application Publication No. 2009/0305364) or from hydrogenation of the olefins in muconic acid (e.g., WO 9,507,996); or 1,3-propanediol produced via fermentation of a recombinant organism, as described in WO 9,821,339 and WO 9,958,686. WO 2002/0104489 and U.S. Patent Application Publication No. 2006/0111411 demonstrate combinations of a thermoplastic starch with an aliphatic polyester as described herein.

Thermoplastic Starches

The fibers disclosed herein can optionally include a thermoplastic starch. Incorporation of thermoplastic starch into the fiber can he used to enhance performance (e.g., improved tactile properties such as softness) and/or reduce cost through addition of low cost raw materials. As used herein, “thermoplastic starch” or “TPS” means a native starch or a starch derivative that has been rendered thermoplastic by treatment with one or more plasticizers. Thermoplastic starch is well known and disclosed in several patents, for example: U.S. Pat. Nos. 5,280,055; 5,314,934; 5,362,777; 5,844,023; 6,214,907; 6,242,102; 6,096,809; 6,218,321; 6,235,815; 6,235,816; and 6,231,970, each incorporated herein by reference.

Since natural starch has a granular structure, the starch is destructurized before being melt processed and spun like a thermoplastic material. One exemplary way to gelatinize starch is to destructurize it in the present of a solvent, which acts as a plasticizer. For example, the starch can be destructurized in water. The solvent and the starch mixture can be heated under pressurized conditions and shear to accelerate the gelatinization process. Chemical or enzymatic agents can also be used to destructurize, oxidize, and/or derivatize the starch. Destructurization is complete when there are no lumps in the starch that impact that fiber spinning process. Any remaining undestructured starch particle sizes are less than 30 μm, preferably less 20 μm, more preferably less than 10 μm, or less than 5 μm. The residual particle size can be determined by pressing the final formulation into a thin film (50 μm or less) and placing the film into a light microscope under cross polarized light. Under cross polarized light, the signature maltese cross, indicative of undestructured starch, can be observed. If the average size of these particle is above the target range, the destructured starch has not been prepared properly and is not useful for production of fine diameter filaments.

Non-limiting examples of destructurized starches contemplated in the fibers disclosed herein include corn starch, potato starch, sweet potato starch, wheat starch, sago palm starch, tapioca starch, rice starch, soybean starch, arrow root starch, bracken starch, lotus starch, cassava starch, waxy maize starch, high amylase corn starch, and commercial amylase powder. Blends of starches can also be used. Though any starch can be used, natural starches derived from agricultural resources are specifically contemplated, as natural starches offer an advantage of being abundant in supply, easily replenishable, and cost effective. Naturally occurring starches, particularly corn starch, wheat starch, and waxy maize starch, are in particular contemplated for use due to their price and availability.

Modified starch can also be used in the fibers. Modified starch is anon-substituted or substituted starch that has had its native molecular weight characteristics changed (i.e. the molecular weight is changed but no other changes are necessarily made to the starch). If modified starch is desired, chemical modifications of starch typically include acid or alkali hydrolysis and oxidative chain scission to reduce molecular weight and molecular weight distribution. Natural unmodified starch generally has a very high weight average molecular weight and a broad molecular weight distribution (e.g., natural corn starch has an average molecular weight of up to about 60,000,000 g/mol). The average molecular weight of starch can be reduced to a desirable range by acid reduction, oxidation reduction, enzymatic reduction, hydrolysis (acid or alkaline catalyzed), physical/mechanical degradation (e.g., via the thermomechanical energy input of the processing equipment), or combinations thereof. The thermomechanical method and the oxidation method offer an additional advantage when carried out in situ. The exact chemical nature of the starch and molecular weight reduction method is not critical as long as the average molecular weight is in an acceptable range.

Ranges of the weight average molecular weight for starch or starch blends added to the melt can be about 3,000 g/mol to about 8,000,000 g/mol, about 10,000 g/mol to about 5,000,000 g/mol, about 10,000 to about 2,000,000 g/mol, and about 20,000 g/mol to about 3,000,000 g/mol. In various embodiments, the weight average molecular weight is otherwise within the above ranges but 1,000,000 g/mol or less, or 700,000 g/mol or less.

Substituted starch can be used. If substituted starch is desired, chemical modifications of starch typically include etherification and esterification. Substituted starches may be desired for better compatibility or miscibility with the thermoplastic polymer and plasticizer. Alternatively, modified and substituted starches can be used to aid in the destructuring process by increasing the gelatinization process. However, this must be balanced with the reduction in the rate of degradability. The degree of substitution of the chemically substituted starch can be from about 0.01 to 3.0. A low degree of substitution, 0.01 to 0.06, is also contemplated.

Specifically contemplated modified starches include hydroxyethyl starch, hydroxypropyl starch, carboxymethylated starch, starch phosphate, starch acetate, a cationic starch, and (2-hydroxy-3-trimethyl(ammoniumpropyl) starch chloride. Also contemplated are starches modified by acid, base, enzyme hydrolysis, oxidation, and combinations thereof.

The weight of starch in the fiber includes starch and its naturally occurring bound water content. The term “bound water” means the water found naturally occurring in starch and before the starch is mixed with other components to make the fibers as disclosed herein. The term “free water” means the water that is added in making the fibers as disclosed herein. A person of ordinary skill in the art would recognize that once the components are mixed, water can no longer be distinguished by its origin. The starch typically has a bound water content of about 5% to 16% by weight of starch. It is known that additional free water may be incorporated in the polar solvent or plasticizer, and not included in the weight of the starch.

Plasticizer

A plasticizer can be used to destructurize the starch and enable the starch to flow, e.g., create a thermoplastic starch. The same plasticizer can be used to increase melt processability or two separate plasticizers can be used. The plasticizers can also improve the flexibility of the final products (e.g., fibers), which is believed to be due to the lowering of the glass transition temperature of the destructurized starch and/or thermoplastic polymer by the plasticizer. The plasticizer(s) should be substantially compatible with the polymeric components of the fibers as disclosed herein so that the plasticizers may effectively modify the properties of the fibers. As used herein, the term “substantially compatible” means when heated to a temperature above the softening and/or the melting temperature of the destructurized starch, the plasticizer is capable of forming a substantially homogeneous mixture with starch.

An additional plasticizer or diluent for the thermoplastic polymer may be present to lower the polymer's melting temperature and improve overall compatibility with the thermoplastic starch blend. Furthermore, thermoplastic polymers with higher melting temperatures may be used if plasticizers or diluents are present which suppress the melting temperature of the polymer. The plasticizer will typically have a weight average molecular weight of less than about 100,000 g/mol and can be a block or random copolymer or terpolymer where one or more of the chemical species is compatible with another plasticizer, starch, polymer, or combinations thereof.

A non-limiting example of a useful plasticizer includes polyols. Specific polyols contemplated include mannitol, sorbitol, glycerin, and combinations thereof. It is also contemplated that the plasticizer can be glycerol, ethylene glycol, propylene glycol, ethylene diglycol, propylene diglycol, ethylene triglycol, propylene triglycol, polyethylene glycol, polypropylene glycol, 1,2-propanediol, 1,3-propanediol, 1,2-butanediol, 1,3-butanediol, 1,4-butanediol, 1,5-pentanediol, 1,6-hexanediol, 1,5-hexanediol, 1,2,6-hexanetdiol, 1,3,5-hexanetriol, neopentyl glycol, trimethylolpropane, pentaerythritol, sorbitol, glycerol ethoxylate, tridecyl adipate, isodecyl benzoate, tributyl citrate, tributyl phosphate, dimethyl sebacate, urea, pentaerythritol ethoxylate, sorbitol acetate, pentaerythritol acetate, ethylenebisformamide, sorbitol diacetate, sorbitol monoethoxylate, sorbitol diethoxylate, sorbitol hexaethoxylate, sorbitol dipropoxylate, aminosorbitol, trihydroxymethylaminomethane, glucoseREG, a reaction product of ethylene oxide with glucose, trimethylolpropane monoethoxylate, mannitol monoacetate, mannitol monoethoxylate, butyl glucoside, glucose monoethoxylate, α-methyl glucoside, carboxymethylsorbitol sodium salt, sodium lactate, polyglycerol monoethoxylate, erythriol, arabitol, adonitol, xylitol, iditol, galactitol, allitol, malitol, formaide, N-methylformamide, dimethyl sulfoxide, an alkylamide, a polyglycerol having 2 to 10 repeating units, and combinations thereof.

A low weight average molecular weight plasticizer can be used. Suitable molecular weights are less than about 20,000 g/mol, less than about 5,000 g/mol, and less than about 1,000 g/mol. The amount of plasticizer is dependent upon the molecular weight, amount of starch, and the affinity of the plasticizer for the starch.

Generally, the amount of plasticizer increases with increasing molecular weight of starch. Typically, the plasticizer present in the final multicomponent fiber contains about 2% to about 90%, about 5% to about 70%, or about 10% to about 50%, based upon the total weight of the fiber. The plasticizer can be present in one or more of the components. All of the plasticizers disclosed herein can be used alone or in mixtures thereof.

A further plasticizer option is the use of polymers that are substantially compatible with thermoplastic starch. Non-limiting examples include PEG, PEO, PVOH and EVOH. These plasticizer polymers can also be used in combination with polyol plasticizers, as described above.

Bio-Based Plasticizers

The plasticizer can be bio-based. Specifically contemplated bio-based plasticizers include erythritol, arabitol, adonitol, xylitol, mannitol, iditol, galactitol, allitol, malitol, glycerol, ethylene glycol, propylene glycol, ethylene diglycol, propylene diglycol, ethylene triglycol, propylene triglycol, polyethylene glycol, polypropylene glycol, 1,2-propanediol, 1,3-propanediol, 1,2-butanediol, 1,3-butanediol, 1,4-butanediol, 1,5-pentanediol, 1,6-hexanediol, sorbitol, glycerol ethoxylate, tributyl citrate, sorbitol acetate, sorbitol diacetate, sorbitol monoethoxylate, sorbitol diethoxylate, sorbitol hexaethoxylate, sorbitol dipropoxylate, aminosorbitol, glucose/PEG, mannitol monoacetate, mannitol monoethoxylate, butyl glucoside, glucose monoethoxylate, α-methyl glucoside, carboxymethylsorbitol sodium salt, sodium lactate, polyglycerol monoethoxylate, and combinations thereof.

Formation of a bio-based plasticizer can be by any means known in the art. For example, bio-based ethylene glycol can be produced from ethanol. The ethanol is dehydrated to ethylene and then oxidized to ethylene oxide via oxygen using a catalyst. Ethylene oxide is then hydrolyzed to ethylene glycol. Bio-ethylene glycol production is exemplified in U.S. Patent Application Publication No. 2009/0245430. Diethylene glycol and triethyleneglycol are generated during the synthesis of ethylene glycol. 1,2-propyleneglycol can be synthesized from bio-propylene. The hydrogenolysis of glycerol and sugars such as sorbitol can also produce bio-glycols including ethylene glycol and polyethylene glycol (see e.g., U.S. Patent Application Publication Nos. 2009/0143612 and 2008/0103339). 1,3-propanediol is produced by fermentation of a genetically modified organism as exemplified in WO 98/21339. 1,2-butanediol, 1,3-butanediol, and 1,4-butanediol can be produced by hydrocracking sorbitol, as taught in WO 2006/092085. Alternatively, 1,4-butanediol can be produced by fermentation using genetically engineered organisms (see e.g., WO 2010/141920 or WO 2010/085731). 1,5-pentanediol or 1,6-hexanediol can be prepared by hydrogenating pentanedioic acid or hexanedioic acid with hydrogen and a catalyst (see e.g., U.S. Patent Application Publication No. 2011/012926). These acids can be produced by fermentation processes, as exemplified in JP 49008874 and WO 2011/003034.

Additives

Optionally, other ingredients can be incorporated into the fibers. The optional ingredient(s) can be incorporated into the fiber per se, or into one or more components of the fiber (e.g., the thermoplastic starch, thermoplastic polymer, or both). These optional ingredients can be present in quantities of less than about 50%, about 0.1% to about 20%, and about 0.1% to about 12% by weight of the fiber. The optional materials can be used to modify the processability and/or to modify physical properties such as elasticity, tensile strength and modulus of the final product. Other benefits include, but are not limited to, stability including oxidative stability, brightness, color, flexibility, resiliency, workability, processing aids, viscosity modifiers, and odor control. Non-limiting examples of classes of additives contemplated for the fibers and/or components disclosed herein include perfumes, dyes, pigments, nanoparticles, antistatic agents, fillers, polymer stabilizer packages, thermoplastic starch stabilizer packages, and combinations thereof. Specifically contemplated is addition of one or more additive. For example, both a perfume and a colorant (e.g., pigment and/or dye) can be present in the fiber. The additive(s), when present, is/are present in a weight percent of about 0.05 wt % to about 20 wt %, or about 0.1 wt % to about 10 wt %. Specifically contemplated weight percentages include about 0.5 wt %, about 0.6 wt %, about 0.7 wt %, about 0.8 wt %, about 0.9 wt %, about 1 wt %, about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.1 wt %, about 2.2 wt %, about 2.3 wt %, about 2.4 wt %, about 2.5 wt %, about 2.6 wt %, about 2.7 wt %, about 2.8 wt %, about 2.9 wt %, about 3 wt %, about 3.1 wt %, about 3.2 wt %, about 3.3 wt %, about 3.4 wt %, about 3.5 wt %, about 3.6 wt %, about 3.7 wt %, about 3.8 wt %, about 3.9 wt %, about 4 wt %, about 4.1 wt %, about 4.2 wt %, about 4.3 wt %, about 4.4 wt %, about 4.5 wt %, about 4.6 wt %, about 4.7 wt %, about 4.8 wt %, about 4.9 wt %, about 5 wt %, about 5.1 wt %, about 5.2 wt %, about 5.3 wt %, about 5.4 wt %, about 5.5 wt %, about 5.6 wt %, about 5.7 wt %, about 5.8 wt %, about 5.9 wt %, about 6 wt %, about 6.1 wt %, about 6.2 wt %, about 6.3 wt %, about 6.4 wt %, about 6.5 wt %, about 6.6 wt %, about 6.7 wt %, about 6.8 wt %, about 6.9 wt %, about 7 wt %, about 7.1 wt %, about 7.2 wt %, about 7.3 wt %, about 7.4 wt %, about 7.5 wt %, about 7.6 wt %, about 7.7 wt %, about 7.8 wt %. about 7.9 wt %, about 8 wt %, about 8.1 wt %, about 8.2 wt %, about 8.3 wt %, about 8.4 wt %, about 8.5 wt %, about 8.6 wt %, about 8.7 wt %, about 8.8 wt %, about 8.9 wt %, about 9 wt %, about 9.1 wt %, about 9.2 wt %, about 9.3 wt %, about 9.4 wt %, about 9.5 wt %, about 9.6 wt %, about 9.7 wt %, about 9.8 wt %, about 9.9 wt %, and about 10 wt %.

Slip agents can be used to help reduce the tackiness or coefficient of friction in the fiber. Also, slip agents may be used to improve fiber stability, particularly in high humidity or temperatures. A suitable slip agent is polyethylene. A salt can also be added to the melt. The salt can help to solubilize the starch, reduce discoloration, make the fiber more water responsive, and/or be used as a processing aid. A salt can also function to help reduce the solubility of a binder so it does not dissolve. However, when the binder is placed in water or flushed, the salt will dissolve, enabling the binder to dissolve, creating a more aqueous responsive product. Non-limiting examples of salts include sodium chloride, potassium chloride, sodium sulfate, ammonium sulfate and mixtures thereof.

As used herein the term “perfume” is used to indicate any odoriferous material that is subsequently released from the fiber as disclosed herein. A wide variety of chemicals are known for perfume uses, including materials such as aldehydes, ketones, alcohols, and esters. More commonly, naturally occurring plant and animal oils and exudates including complex mixtures of various chemical components are known for use as perfumes. The perfumes herein can be relatively simple in their compositions or can include highly sophisticated complex mixtures of natural and synthetic chemical components, all chosen to provide any desired odor. Typical perfumes can include, for example, woody/earthy bases containing exotic materials, such as sandalwood, civet, and patchouli oil. The perfumes can be of a light floral fragrance (e.g rose extract, violet extract. and lilac). The perfumes can also be formulated to provide desirable fruity odors, e.g. lime, lemon, and orange. The perfumes delivered in the fibers and articles as disclosed herein can be selected for an aromatherapy effect, such as providing a relaxing or invigorating mood. As such, any material that exudes a pleasant or otherwise desirable odor can be used as a perfume active in the fibers and articles as disclosed herein.

A pigment or dye can be inorganic, organic, or a combination thereof. Specific examples of pigments and dyes contemplated include pigment Yellow (C.I. 14), pigment Red (C.I. 48:3), pigment Blue (C.I. 15:4), pigment Black (C.I. 7), and combinations thereof. Specific contemplated dyes include water soluble ink colorants like direct dyes, acid dyes, base dyes, and various solvent soluble dyes. Examples include, but are not limited to, FD&C Blue 1 (C.I. 42090:2), D&C Red 6(C.I. 15850), D&C Red 7(C.I. 15850:1), D&C Red 9(C.I. 15585:1), D&C Red 21(C.I. 45380:2), D&C Red 22(C.I. 45380:3), D&C Red 27(C.I. 45410:1), D&C Red 28(C.I. 45410:2), D&C Red 30(C.I. 73360), D&C Red 33(C.I. 17200), D&C Red 34(C.I. 15880:1), and FD&C Yellow 5(C.I.

19140:1), FD&C Yellow 6(C.I. 15985:1), FD&C Yellow 10(C.I. 47005:1), D&C Orange 5(C.I. 45370:2), and combinations thereof.

Contemplated fillers include, but are not limited to inorganic fillers such as, for example, the oxides of magnesium, aluminum, silicon, and titanium. These materials can be added as inexpensive fillers or processing aides. Other inorganic materials that can function as fillers include hydrous magnesium silicate, titanium dioxide, calcium carbonate, clay, chalk, boron nitride, limestone, diatomaceous earth, mica glass quartz, and ceramics. Additionally, inorganic salts, including alkali metal salts, alkaline earth metal salts, and phosphate salts, can be used. Additionally, alkyd resins can also be added to the fibers. Alkyd resins include a polyol, a polyacid, and/or an anhydride.

Contemplated surfactants include anionic surfactants, amphoteric surfactants, or a combination of anionic and amphoteric surfactants, and combinations thereof, such as surfactants disclosed, for example, in U.S. Pat. Nos. 3,929,678 and 4,259,217 and in EP 414 549, WO 93/08876 and WO 93/08874.

Contemplated nanoparticles have at least one dimension in the range of 1 to 100 nm and include metals, metal oxides, allotropes of carbon, clays, organically modified clays, sulfates, nitrides, hydroxides, oxy/hydroxides, particulate water, insoluble polymers, silicates, phosphates and carbonates. Examples include silicon dioxide, carbon black, graphite, graphene, fullerenes. expanded graphite, carbon nanotuhes, talc, calcium carbonate, bentonite, montmorillonite, kaolin, silica, aluminosilicates, boron nitride, aluminum nitride, barium sulfate, calcium sulfate, antimony oxide, feldspar, mica, nickel, copper, iron, cobalt, steel, gold, silver, platinum, aluminum, wollastonite, aluminum oxide, zirconium oxide, titanium dioxide, cerium oxide, zinc oxide, magnesium oxide, tin oxide, iron oxides (Fe₂O₃, Fe₃O₄) and mixtures thereof. Nanoparticles can increase the strength, thermal stability, and/or abrasion resistance of the fibers disclosed herein, and can give the fibers electric properties.

Contemplated anti-static agents include fabric softeners that are known to provide anti-static benefits. For example, those fabric softeners that have a fatty acyl group that has an iodine value of above 20, such as N,N-di(tallowoyl-oxy-ethyl)-N,N-dimethyl ammonium methylsulfate are contemplated for use.

Nonwoven Webs and Articles Made from Fibers as Disclosed Herein

The multicomponent fibers disclosed herein can be used for any purposes for which fibers are conventionally used. This includes, without limitation, incorporation into nonwoven or woven webs and substrates. The fibers hereof can be converted to nonwovens by any suitable methods known in the art. Continuous fibers can be formed into a web using industry standard spunbond type technologies while staple fibers can be formed into a web using industry standard carding, airlaid, or wetlaid technologies. Typical bonding methods include: calendar (pressure and heat), thru-air heat, mechanical entanglement, hydrodynamic entanglement, needle punching, and chemical bonding and/or resin bonding. The calendar, thru-air heat, and chemical bonding are possible bonding methods for the ester condensate and polymer multicomponent fibers. Thermally bondable fibers are used in the pressurized heat and thru-air heat bonding methods.

The multicomponent fibers disclosed herein can also be bonded or combined with other synthetic or natural fibers to make nonwoven articles. The synthetic or natural fibers may be blended together in the forming process or used in discrete layers. Suitable synthetic fibers include fibers made from polypropylene, polyethylene, polyester, polyacrylates, and copolymers thereof and mixtures thereof. Natural fibers include cellulosic fibers and derivatives thereof. Suitable cellulosic fibers include those derived from any tree or vegetation, including hardwood fibers, softwood fibers, hemp, and cotton. Also included are fibers made from processed natural cellulosic resources such as rayon.

The multicomponent fibers disclosed herein can be used to make nonwovens, among other suitable articles. Nonwoven articles are defined as articles that contains greater than 15% of a plurality of fibers that are continuous or non-continuous and physically and/or chemically attached to one another. The nonwoven may be combined with additional nonwovens or films to produce a layered product used either by itself or as a component in a complex combination of other materials, such as a baby diaper or feminine care pad. These articles include disposable, nonwoven articles. The resultant products can be used in filters for air, oil and water; vacuum cleaner filters; furnace filters; face masks; coffee filters, tea or coffee bags; thermal insulation materials and sound insulation materials; nonwovens for one-time use sanitary products such as diapers, feminine pads, and incontinence articles; biodegradable textile fabrics for improved moisture absorption and softness of wear such as micro fiber or breathable fabrics; an electrostatically charged, structured web for collecting and removing dust; reinforcements and webs for hard grades of paper, such as wrapping paper, writing paper, newsprint, corrugated paper board, and webs for tissue grades of paper such as toilet paper, paper towel, napkins and facial tissue; medical uses such as surgical drapes, wound dressing, bandages, dermal patches and self-dissolving sutures; and dental uses such as dental floss and toothbrush bristles. The fibrous web may also include odor absorbents, termite repellants, insecticides, rodenticides, and the like, for specific uses. The resultant product absorbs water and oil and can be used in oil or water spill clean-up, or controlled water retention and release for agricultural or horticultural applications. The resultant starch fibers or fiber webs can also be incorporated into other materials such as saw dust, wood pulp, plastics, and concrete, to form composite materials, which can be used as building materials such as walls, support beams, pressed boards, dry walls and backings, and ceiling tiles; other medical uses such as casts, splints, and tongue depressors; and in fireplace logs for decorative and/or burning purpose. Example articles disclosed herein include disposable nonwovens for hygiene and medical applications. Hygiene applications include such items as wipes; diapers, particularly the top sheet or back sheet; and feminine pads or products, particularly the top sheet.

The multicomponent fibers disclosed herein can be used to make disposable nonwoven articles. The articles are commonly flushable. The term “flushable” as used herein refers to materials that are capable of dissolving, dispersing, disintegrating, and/or decomposing in a septic disposal system such as a toilet to provide clearance when flushed down the toilet without clogging the toilet or any other sewage drainage pipe. The fibers and resulting articles can also be aqueous responsive. The term “aqueous responsive” as used herein means that when placed in water or flushed, an observable and measurable change results. Typical observations include noting that the article swells, pulls apart, dissolves, or observing a general weakened structure.

The nonwoven products produced from the fibers exhibit certain mechanical properties, particularly, strength, flexibility, softness, and absorbency. Measures of strength include dry and/or wet tensile strength. Flexibility is related to stiffness and can be attributed to softness. Softness is generally described as a physiologically perceived attribute that is related to both flexibility and texture. Absorbency relates to the products' ability to take up fluids as well as the capacity to retain them. The tensile strength of a fiber as disclosed herein is greater than 25 Mega Pascal (MPa). The fibers as disclosed herein can have a tensile strength of greater than 50 MPa, greater than 75 MPa, or greater than 100 MPa. Tensile strength is measured using an Instron following a procedure described by ASTM standard D 3822-91 or an equivalent test.

Process of Making the Fibers, Nonwovens, and Articles as Disclosed Herein Compounding: The first step in producing a multicomponent fiber is the compounding or mixing step during which the raw materials are heated, typically under shear. The shearing in the presence of heat will result in a homogeneous melt with proper selection of the materials (e.g., thermoplastic polymer and/or thermoplastic starch). The melt is then placed in an extruder where fibers are formed. A collection of fibers is combined together using heat, pressure, chemical binder, mechanical entanglement, and combinations thereof resulting in the formation of a nonwoven web. The nonwoven is then assembled into an article.

The objective of the compounding step is to produce a homogeneous melt composition containing the starch, polymer, and/or plasticizer. If a constituent is being produced that is only starch or polymer and not both, the compounding step will be modified to account for the desired composition. Ideally, the melt composition is homogeneous, meaning that a uniform distribution is found over a large scale and that no distinct regions are observed.

The resultant melt composition can be essentially free of water to spin fibers. “Essentially free” is defined as not creating substantial problems, such as causing bubbles to form, which may ultimately break the fiber while spinning. The total water content of the melt composition is less than about 1%. less than about 0.5%, or less than 0.1%. The total water content includes the bound and free water. To achieve this low water content, the starch and polymers are optionally dried before processed and/or a vacuum is applied during processing to remove any free water. The thermoplastic starch is dried at 40-90° C. before spinning. The water content can he measured using a moisture analyzer. A typical system is a weight loss method using an analytical balance coupled with an infrared lamp to heat the sample. If this type of system is used, a standard protocol is to weigh out 10 grams of thermoplastic starch into the balance and heat the thermoplastic starch for 10 minutes at 110° C. The difference in the initial and final weight is taken to be the moisture content.

In general, any method using heat, mixing, and pressure can be used to combine the polymer, starch, and/or plasticizer. The particular order or mixing, temperatures, mixing speeds or time, and equipment are not critical as long as the starch does not significantly degrade and the resulting melt is homogeneous.

A method of mixing for a starch and two polymer blend is as follows: The polymer having a higher melting temperature is heated and mixed above its melting point. Typically, this is 30° to 70° C. above its melting temperature. The mixing time is about 2 to about 10 minutes, usually around 5 minutes. The polymer is then cooled, typically to 120° to 180° C., above the solidification temperature of the polymer, in this case polypropylene.

The starch is fully destructurized. This starch can be destructurized by dissolving it in water at 70° to 100° C. at a concentration of 10 to 90% starch depending upon the molecular weight of the starch, the desired viscosity of the destructurized starch, and the time allowed for destructurizing. In general, about 15 minutes is sufficient to destructurize the starch but 10 minutes to 30 minutes may be necessary depending upon conditions. A plasticizer can be added to the destructurized starch solution if desired.

The cooled polymer from step 1 and the destructurized starch from step 2 are then combined. The polymer and starch can be combined in an extruder or a batch mixer with shear. The mixture is heated, typically to about 120° to 200° C., which results in vaporization of any water. If it is necessary to flash off all of the water, the mixture should be mixed until all of the water is gone. Typically, the mixing in this step lasts about 30 seconds to about 15 minutes, but typically washing lasts for about 5 minutes. A homogenous blend of starch and polymer is formed. A second polymer is then added to the homogeneous blend of step 3. This second polymer may be added at room temperature or after it has been melted and mixed. The homogeneous blend from step 3 is continued to be mixed at temperatures from about 120° to 180° C. The temperatures above 100° C. are needed to prevent condensation. If not added in step 2, the plasticizer may be added now. The blend is mixed until it is homogeneous, which is identified by the absence of distinct regions in the blend. Mixing time is generally from about 2 to about 10 minutes, commonly around 5 minutes.

As will be appreciated by one skilled in the art of compounding, numerous variations and alternate methods and conditions can be used for destructuring the starch and formation of the starch melt including, without limitation, via the feed port location and screw extruder profile.

A suitable mixing device is a multiple mixing zone twin screw extruder with multiple injection points. The multiple injection points can be used to add the destructurized starch and the polymer. A twin screw batch mixer or a single screw extrusion system can also be used. As long as sufficient mixing and heating occurs, the particular equipment used is not critical.

An alternative method for compounding the materials involves adding the plasticizer, starch, and polymer to an extrusion system where they are mixed at progressively increasing temperatures. For example, in a twin screw extruder with six heating zones, the first three zones may be heated to 90°, 120°, and 130° C. and the last three zones will be heated above the melting point of the polymer. This procedure results in minimal thermal degradation of the starch and allows for the starch to be fully destructured before intimate mixing with the thermoplastic materials.

Another process contemplated uses a higher temperature melting polymer where the starch is injected at the very end of the process after it has been destructurized and optimally combined with the plasticizer. The starch is only at a higher temperature for a very short amount of time, which is not enough time to burn.

An example of compounding destructured thermoplastic starch would be to use a Baker Perkins (25 mm diameter 40:1 length to diameter ratio) co-rotating twin-screw extruder set at 400 RPM with the first heated zone set at 80° C., the second at 120° C. and the remaining five heating zones set 160° C. A vacuum is attached after the penultimate section pulling a vacuum of 10 atm. Starch powder and plasticizer (e.g., sorbitol), along with polypropylene and acrylic acid modified polypropylene are individually fed into the feed throat at the base of the extruder, for example using mass-loss feeders at a combined rate of 30 lbs/hour (13.6 kg/hour) at a 60/40 weight ratio of starch/plasticizer. Processing aids can be added along with the starch or plasticizer. For example, magnesium separate can be added, for example, at a level of 0-1%, by weight, of the thermoplastic starch component.

Fibers can be spun from a melt composition as disclosed herein. In melt spinning, there is no mass loss in the extrudate. Melt spinning is differentiated from other spinning, such as wet or dry spinning from solution, where a solvent is being eliminated by volatilizing or diffusing out of the extrudate resulting in a mass loss.

Spinning will occur between 120° C. to about 320° C., usually between 185° C. to about 250° C. Fiber spinning speeds of greater than 100 meters/minute are required. The fiber spinning speed is about 1,000 to about 10,000 meters/minute, about 1,500 to about 7,000 meters/minute, or about 2,000 to about 5,000 meters/minute. The melt composition is spun fast to avoid brittleness in the fiber.

Continuous fibers can be produced through spunbond methods or meltblowing processes or non-continuous (staple fibers) fibers can be produced. The various methods of fiber manufacturing can also be combined to produce a combination technique.

The homogeneous blend can be melt spun into multicomponent fibers using conventional melt spinning equipment. The equipment will be chosen based on the desired configuration of the multicomponent. Commercially available melt spinning equipment is available from Hills, Inc. located in Melbourne, Fla. The temperature for spinning is about 120° C. to about 300° C. The processing temperature is determined by the chemical nature, molecular weights and concentration of each component. The fibers spun can be collected using conventional godet winding systems or through air drag attenuation devices. If the godet system is used, the fibers can be further oriented through post extrusion drawing at temperatures from about 50° C. to about 200° C. The drawn fibers may then be crimped and/or cut to form non-continuous fibers (staple fibers) used in a carding, air-laid, or fluid-laid process.

In the process of spinning fibers, particularly as the temperature is increased above 105° C., typically it is desirable for residual total water levels to be 1%, by weight of the fiber, or less, alternately 0.5% or less, or 0.15% or less.

### EXAMPLES

The examples below further illustrate the present invention but are not intended to be limiting. All thermoplastic polymers noted below are bio-based.

Example 1 A sheath-core bicomponent fiber is produced with a polyethylene and thermoplastic starch core: The blend for the core is compounded by first preparing destructured starch and then adding the thermoplastic polymers. The thermoplastic starch core is prepared by first compounding a mixture of 70 wt % Tate & Lyle Ethylex 2005S and 30 wt % sorbitol powder into the Baker Perkins twin screw at 400 RPM with a temperature profile of 120° C. and a total throughput of 15 lbs per hour. The resultant material is collected onto a belt and either pelletized or broken apart to be added again into the twin-screw. The destructurized thermoplastic starch is then recompounded by adding to the thermoplastic starch a bio-based linear low density polyethylene (nominal melt index of 28) and ethylene acrylic acid (Dow Chemical Primacore 5980) in a ratio of 70 wt % polyethylene, 20 wt % thermoplastic starch, and 10 wt % EAA. This combination is compounded using the Baker Perkins twin screw at 400 RPM with a flat temperature profile of 150° C. in all zones and a total throughput of 40 lbs per hour. The fibers are prepared by pre-drying the thermoplastic starch at 60° C. for 12 hours down to a moisture content of 0.1 wt % and placing this starch into the core of a fiber, combined with a sheath of the same bio-based polyethylene as used in the core. The sheath to core ratio can be changed from 10 wt % sheath and 90 wt % core up to 80 wt % sheath and 20 wt % core. Extrusion takes place at 170° C. Regardless of the fiber ratio, the total bio-based content is well above 50 wt %. All of the components are bio-based except for the EAA, which could also be produced with bio-based starting materials if desired. Example 2 Sheath-core bicomponent fiber is produced similar to example 1 except that bio-based isotactic polypropylene is used in the sheath and core versus bio-based polyethylene. Changes to the process would involve increasing the twin-screw compounding temperature for polymer addition to 180° C. and increasing the fiber spinning temperature to 190° C. The bio-based polypropylene resin has an average melt flow rate of 60.

Example 3 Hollow eight segmented pie bicomponent fiber: The blend for the first segment contains polyethylene. The blend for the second component is compounded as in Example 1 using 70 parts StarDri 100, 10 parts polyethylene and 30 parts sorbitol.

Example 4 Sheath-core bicomponent fiber: The sheath is a bio-based polyethylene resin and the core is a bio-based polypropylene resin.

Example 5 Side-by-side bicomponent fiber: The first component contains a bio-based polypropylene resin and the second component is a bio-based polyamide 6 resin.

Example 6 Sheath-core bicomponent fiber: The sheath polymer is a bio-based polyethylene resin and the core is a bio-based polyethylene terephthalate resin.

Example 7 Sheath-core bicomponent fiber: The sheath polymer is a bio-based polypropylene resin and the core is a bio-based polyethylene terephthalate resin suitable for melt spinning.

While particular examples were given, different combinations of materials, ratios, and equipment such as counter rotating twin screw or high shear single screw with venting could also be used.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A multicomponent fiber comprising a bio-based thermoplastic polymer and optionally a thermoplastic starch, wherein the fiber has a configuration selected from the group consisting of a sheath-core, an islands-in-the-sea. a segmented pie, a side-by-side, a tipped trilobal, and combinations thereof.

2. The multicomponent fiber of claim 1, wherein the configuration is a sheath-core.

3. The multicomponent fiber of claim 1, wherein the bio-based thermoplastic polymer has a molecular weight of 500,000 g/mol or less.

4. The multicomponent fiber of claim 3, wherein the molecular weight is about 5,000 g/mol to about 300,000 g/mol.

5. The multicomponent fiber of claim 3, wherein the molecular weight is about 100,000 o about 200,000 g/mol.

6. The multicomponent fiber of claim 1, wherein the bio-based thermoplastic polymer comprises one or more of a polyolefin, a polyester a polyamide, and copolymers thereof.

7. The multicomponent fiber of claim 1, wherein the bio-based thermoplastic polymer is selected from the group consisting of polypropylene, polyethylene, polypropylene co-polymer, polyethylene co-polymer, polyethylene terephthalate, polybutylene terepthalate, polyethylene 2,5-furandicarboxylate, polybutylene succinate, polyamide-6, polyamide-6,6, and combinations thereof.

8. The multicomponent fiber of claim 1, wherein the bio-based thermoplastic polymer comprises polypropylene.

9. The multicomponent fiber of claim 1, wherein the bio-based thermoplastic polymer comprises polyethylene.

10. The multicomponent fiber of claim 1, wherein at least one component comprises the thermoplastic starch and the bio-based thermoplastic polymer.

11. The multicomponent fiber of claim 1, wherein the thermoplastic starch comprises a destructurized starch and a plasticizer.

12. The multicomponent fiber of claim 11, wherein the plasticizer comprises a polyol.

13. The multicomponent fiber of claim 12, wherein the polyol is selected from the group consisting of mannitol, sorbitol, glycerin, and combinations thereof.

14. The multicomponent fiber of claim 11, wherein the plasticizer is bio-based.

15. The multicomponent fiber of claim 14, wherein the bio-based plasticizer is selected from the group consisting of glycerol, ethylene glycol, propylene glycol, ethylene diglycol, propylene diglycol, ethylene triglycol, propylene triglycol, polyethylene glycol, polypropylene glycol, 1,2-propanediol, 1,3-propanediol, 1,2-butanediol, 1,3-butanediol, 1,4-butanediol, pentanediol, 1,6-hexanediol, sorbitol, glycerol ethoxylate, tributyl citrate, sorbitol acetate, sorbitol diacetate, sorbitol monoethoxylate, sorbitol diethoxylate, sorbitol hexaethoxylate, sorbitol dipropoxylate, aminosorbitol, glucose/PEG, mannitol monoacetate, mannitol monoethoxylate, butyl glucoside, glucose monoethoxylate, α-methyl glucoside, carboxymethylsorbitol sodium salt, sodium lactate, polyglycerol monoethoxylate, erythritol, arabitol, adonitol, xylitol, mannitol, iditol, galactitol, allitol, malitol, and combinations thereof.

16. The multicomponent fiber of claim 14, wherein the bio-based plasticizer is selected from the group consisting of erythritol, arabitol, adonitol, xylitol, mannitol, iditol, galactitol, allitol, malitol, and combinations thereof.

17. The multicomponent fiber of claim 11, wherein the plasticizer is selected from the group consisting of glycerol, ethylene glycol, propylene glycol, ethylene diglycol, propylene diglycol, ethylene triglycol, propylene triglycol, polyethylene glycol, polypropylene glycol, 1,2-propanediol, 1,3-propanediol, 1,2-butanediol, 1,3-butanediol, 1,4-butanediol, 1,5-pentanediol, 1,6-hexanediol, 1,5-hexanediol, 1,2.6-hexanetriol, 1,3,5-hexanetriol, neopentyl glycol, trimethylolpropane, pentaerythritol, sorbitol, glycerol ethoxylate, tridecyl adipate, isodecyl benzoate, tributyl citrate, tributyl phosphate, dimethyl sebacate, urea, pentaerythritol ethoxylate, sorbitol acetate, pentaerythritol acetate, ethylenebisformamide, sorbitol diacetate, sorbitol monoethoxylate, sorbitol diethoxylate, sorbitol hexaethoxylate, sorbitol dipropoxylate, aminosorbitol, trihydroxymethylaminomethane, glucose/PEG, a reaction product of ethylene oxide with glucose, trimethylolpropane monoethoxylate, mannitol monoacetate, mannitol monoethoxylate, butyl glucoside, glucose monoethoxylate, α-methyl glucoside, carboxymethylsorbitol sodium salt, sodium lactate, polyglycerol monoethoxylate, erythriol, arabitol, adonitol, xylitol, mannitol, iditol, galactitol, allitol, malitol, formaide, N-methylformamide, dimethyl sulfoxide, an alkylamide, a polyglycerol having 2 to 10 repeating units, and combinations thereof.

18. The multicomponent fiber of claim 11, wherein the destructurized starch is selected from the group consisting of starch, hydroxyethyl starch, hydroxypropyl starch, carboxymethylated starch, starch phosphate, starch acetate, a cationic starch, (2-hydroxy-3-trimethyl(ammoniumpropyl) starch chloride, a starch modified by acid, base, or enzyme hydrolysis, a starch modified by oxidation, and combinations thereof.

19. The multicomponent fiber of claim 1, further comprising a component comprising a thermoplastic starch.

20. The multicomponent fiber of claim 1, wherein a source of the bio-based thermoplastic polymer is a microorganism extract.

21. The multicomponent fiber of claim 20, wherein the microorganism is one or more of a bacterium and a fungus.

22. The multicomponent fiber of claim 1, wherein the fiber has a bio-based content of at least 10%, based upon the total weight of the fiber.

23. The multicomponent fiber of claim 22, wherein the fiber has a bio-based content of at least 25%, based upon the total weight of the fiber.

24. The multicomponent fiber of claim 22, wherein the fiber has a bio-based content of at least 50%, based upon the total weight of the fiber.

25. The multicomponent fiber of claim 22, wherein the fiber has a bio-based content of at least 75%, based upon the total weight of the fiber.

26. The multicomponent fiber of claim I, wherein the fiber has a diameter of 200 μm or less.

27. The multicomponent fiber of claim wherein the fiber is thermally bondable.

28. A nonwoven web comprising the multicomponent fiber of claim 1.

29. The nonwoven web of claim 28, further comprising synthetic or natural fibers.

30. The nonwoven web of claim 29, wherein the fibers are blended and bonded together.

31. A disposable article comprising the nonwoven web of claim 28.

32. A bicomponent fiber having a sheath-core configuration, the sheath comprising a thermoplastic starch, and the core comprising a bio-based thermoplastic polymer.

33. A bicomponent fiber having a sheath-core configuration, the core comprising a thermoplastic starch, and the sheath comprising a bio-based thermoplastic polymer.
